(19) United States
(12) Patent Application Publication
(10) Pub. No.: US 2026/0106784 A1
(43) Pub. Date: Apr. 16, 2026

(54) Demodulation Reference Signal (DMRS) Port Association for Simultaneous Multi-Panel Transmission User Equipment

(71) Applicant: Telefonaktiebolaget LM Ericsson (publ), Stockholm (SE)

(72) Inventors: Claes Tidestav, Bålsta (SE); Sven Jacobsson, Västra Frölunda (SE); Paulo Valente Klaine, Yokohama Kanagawa (JP)

(21) Appl. No.: 19/099,274

(22) PCT Filed: Aug. 18, 2023
(86) PCT No.: PCT/SE2023/050834

§ 371 Date: Jan. 28, 2025

Related U.S. Application Data
(60) Provisional application No. 63/399,829, filed on Aug. 22, 2022.

(51) Int. Cl. H04L 27/26; H04L 5/00

(52) U.S. Cl. CPC H04L 27/261; H04L 5/0044

(57) ABSTRACT

Embodiments include methods for a user equipment (UE) configured for simultaneous multi-panel transmission (STxMP). Such methods include receiving, from a RAN node, downlink control information (DCI) scheduling physical uplink shared channel (PUSCH) transmission of first and second numbers of layers (L1,L2) associated with respective first and second sounding reference signal (SRS) resource sets. A rank of the PUSCH transmission is equal to a sum of the first number of layers (L1) and the second number of layers (L2). A value in a field of the DCI indicates the following: L1 demodulation reference signal (DMRS) ports of a first subset of DMRS ports associated with the first SRS resource set, and L2 DMRS ports of a second subset of DMRS ports associated with the second SRS resource set. The first and second subsets are non-overlapping. Such methods include transmitting PUSCH and DMRS according to the DCI.

### TECHNICAL FIELD

The present disclosure relates generally to wireless networks, and more specifically to techniques for user equipment (UE) transmission of data in uplink (UL) to a wireless network, particularly for UEs capable of transmitting data via multiple antenna panels concurrently.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN, 199) and a 5G Core (5GC, 198). As shown in the figure, NG-RAN 199 can include gNBs (e.g., 110a,b) and ng-eNBs (e.g., 120a,b) that are interconnected with each other via respective Xn interfaces. The gNBs and ng-eNBs are also connected via the NG interfaces to the 5GC, more specifically to Access and Mobility Management Functions (AMFs, e.g., 130a,b) via respective NG-C interfaces and to User Plane Functions (UPFs, e.g., 140a,b) via respective NG-U interfaces. Moreover, the AMFs can communicate with one or more policy control functions (PCFs, e.g., 150a,b) and network exposure functions (NEFs, e.g., 160a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 111a-b, 121a-b). Depending on the cell in which it is located, a UE (105) can communicate with the gNB or ng-eNB serving that cell via the NR or LTE radio interface, respectively. Although FIG. 1 shows gNBs and ng-eNBs separately, it is also possible that a single NG-RAN node provides both types of functionality.

Each of the gNBs may include and/or be associated with a plurality of Transmission Reception Points (TRPs). Each TRP is typically an antenna array with one or more antenna elements and is located at a specific geographical location. In this manner, a gNB associated with multiple TRPs can transmit the same or different signals from each of the TRPs. For example, multiple TRPs can transmit different versions of a signal to a single UE. Each TRP can use beams for transmission/reception with UEs served by the gNB, as discussed below.

5G/NR technology shares many similarities with fourth-generation LTE. For example, NR uses CP-OFDM (Cyclic Prefix Orthogonal Frequency Division Multiplexing) in the DL and either CP-OFDM or DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval.

In addition to providing coverage via “cells,” as in LTE, NR networks also provide coverage via “beams.” In general, a DL “beam” is a coverage area of a network-transmitted reference signal (RS) that may be measured or monitored by a UE. In NR, for example, DL RS can include any of the following: SS/PBCH block (SSB), channel state information (CSI) RS, tertiary RS (or any other sync signal), positioning RS (PRS), demodulation RS (DMRS), phase-tracking RS (PTRS), etc.

The physical uplink shared channel (PUSCH) carries UL data from UE to gNB. In NR, PUSCH transmissions can be based on CP-OFDM or DFT-S-OFDM, and can use either codebook (CB)-based or non-codebook (NCB)-based precoding. The latter choice is determined by the parameter txConfig that is configured by the network via RRC. CB-based transmission can be used for non-calibrated UEs and/or in FDD arrangements, i.e., when UL/DL reciprocity does not (or is not assumed to) exist. NCB-based transmission relies on UL/DL reciprocity and is primarily used in TDD arrangements.

UEs can transmit sounding RS (SRS) in the UL, which the gNB measures to obtain UL CSI. The gNB uses UL CSI to determine appropriate transmission/reception beams for the UE and/or to perform link adaptation based on setting transmission rank and modulation and coding scheme (MCS). The gNB can also use such UL CSI to determine multiple input multiple output (MIMO) precoding of multiple data streams (called “layers”) for DL (e.g., PDSCH) and UL (e.g., PUSCH) transmissions.

UEs also transmit UL DMRS associated with PUSCH. UL DMRS is a pseudo-random QPSK sequence for CP-OFDM or a low peak-to-average-power ratio (PAPR) sequence for DFT-S-OFDM. UL DMRS facilitates gNB demodulation of PUSCH, particularly in time-varying and frequency-selective channels. DMRS is confined to the scheduled PUSCH bandwidth and duration, but the mapping of DMRS to REs is configurable in frequency and time domains (e.g., via radio resource control, RRC, signaling). There are two mapping types in the frequency domain: type 1 (comb based with two CDM groups) or type 2 (non-comb based with three CDM groups). In the time-domain, DMRS can be either single symbol or double symbol (i.e., in pairs of two adjacent symbols).

An “antenna port” is a 3GPP-defined abstraction of one or more physical antenna elements used to transmit a signal and any beamforming applied to these elements for the transmission. For example, even if two signals are transmitted using the same physical antenna elements, they will correspond to different antenna ports if they are beamformed differently (e.g., with different weights), since the beamforming will cause the signals to experience different channels.

DMRS associated with PUSCH are configured according to antenna ports (or “DMRS ports”). DMRS ports are mapped to REs in a single CDM group, and different DMRS ports mapped to the same CDM group are separated (or distinguished) by a length-2 frequency division (FD) orthogonal cover code (OCC) and, in the case of double symbol DMRS, a length-2 time division (TD) OCC. From the UE's perspective, the number of DMRS ports used for PUSCH transmission coincides with the transmission rank, i.e., one DMRS port per layer transmitted on PUSCH. DMRS port mapping is signaled to the UE via physical layer DL control information (DCI), e.g., in an “antenna ports” field.

For UEs, it can be beneficial and/or necessary to have the capability of receiving and transmitting in many different directions. As such, it is beneficial to have a UE antenna implementation that can generate nearly omni-directional coverage as well as narrow, high-gain beams to compensate for poor propagation conditions at high (e.g., millimeter wave, mmW) frequencies. One possible implementation is multiple UE antenna panels pointing in different directions.

### SUMMARY

Conventionally, it has been left to UE discretion to choose one or more of its antenna panels for an UL transmission. 3GPP Rel-18 includes a study on simultaneous multi-panel transmission (STxMP), with a goal of the RAN (e.g., serving gNB) having the ability to schedule a UE UL transmission across multiple UE antenna panels, with the transmissions from the multiple panels being intended for the same TRP or different TRPs.

The Rel-18 study has not determined how to map and/or associate DMRS ports for STxMP. One proposal is that the total number of DMRS ports and the assumed rank for DMRS port mapping (i.e., which dictates the antenna-port table to be used) should be the total number of PUSCH layers transmitted from the STxMP-capable UE (i.e., sum of layers from different antenna panels). This would be specified by a single “antenna ports” DCI field in DCI. Although this approach minimizes DCI signaling overhead, it also causes various problems, issues, and/or difficulties for UEs and RAN nodes (e.g., gNBs), including in relation to UE transmission of SRS.

An object of embodiments of the present disclosure is to improve communication between UEs and RAN nodes, such as by providing, enabling, and/or facilitating solutions to exemplary problems summarized above and described in more detail below.

Embodiments include methods (e.g., procedures) for a UE configured for simultaneous multi-panel transmission (STxMP).

These exemplary methods include receiving, from a RAN node, downlink control information (DCI) scheduling physical uplink shared channel (PUSCH) transmission of a first number of layers (L1) associated with a first sounding reference signal (SRS) resource set and of a second number of layers (L2) associated with a second SRS resource set. A rank of the PUSCH transmission is equal to a sum (L1+L2) of the first number of layers (L1) and the second number of layers (L2). Also, a value in a field in the DCI indicates the following:
L1 demodulation reference signal, DMRS, ports of a first subset of DMRS ports associated with the first SRS resource set, and
L2 DMRS ports of a second subset of DMRS ports associated with the second SRS resource set; and
   The first and second subsets of DMRS ports are non-overlapping. These exemplary methods also include transmitting PUSCH and DMRS according to the received DCI.

In some embodiments, the first and second subsets of DMRS ports are independent of a rank associated with the first SRS resource set and a rank associated with the second SRS resource set. In some embodiments, the value of the field in the DCI indicates DMRS ports based on a table mapping the value to DMRS ports. The table is selected based on the rank of the PUSCH transmission.

In some embodiments, the UE is configured for simultaneous transmission of the first and second SRS resource sets via respective first and second antenna panels. The first subset of DMRS ports comprises DMRS port 0 and DMRS port 1, and the second subset of DMRS ports comprises DMRS port 2 and DMRS port 3.

In some of these embodiments, the rank of the PUSCH transmission is equal to 3. A first value of the field in the DCI corresponds to the first number of layers (L1) equal to 2 and the second number of layers (L2) equal to 1, with the first value of the field indicates a first entry in the selected table. Also, the first entry is mapped to DMRS ports 0 and 1 for the transmission on the L1=2 layers and to DMRS port 2 for the transmission on the L2=1 layer. Also, a second value of the field in the DCI corresponds to the first number of layers (L1) equal to 1 and the second number of layers (L2) equal to 2, with the second value of the field indicating a second entry in the selected table. Also, the second entry is mapped to DMRS port 0 for the transmission on the L1=1 layer and to DMRS ports 2 and 3 for the transmission on the L2=2 layers.

In some embodiments, the first subset of DMRS ports are mapped to resource elements of a first CDM group and the second subset of DMRS ports are mapped to resource elements of a second CDM group. In some embodiments, a second field in the DCI indicates the first number of layers (L1) and the second number of layers (L2). In some of these embodiments, the second field is one of the following: a precoding information and number of layers field, or an SRS resource indicator field.

In some embodiments, these exemplary methods also include receiving, from the RAN node, an SRS configuration configuring the first and second SRS resource sets. Each SRS resource set includes one or more SRS resources, and each SRS resource is associated with one or more SRS ports. In some of these embodiments, these exemplary methods also include transmitting, SRS resources of the first and second SRS resource sets via respective first and second UE antenna panels, in accordance with the SRS configuration.

In some embodiments, the PUSCH and DMRS are transmitted simultaneously via two UE antenna panels. The L1 DMRS ports are associated with a first TRP of the RAN node and the L2 DMRS ports are associated with a second TRP of the RAN node. Each TRP is a destination for PUSCH and DMRS transmitted via a corresponding one of the two UE antenna panels.

Other embodiments include exemplary methods (e.g., procedures) for a RAN node configured to receive transmissions from a UE arranged for simultaneous multi-panel transmission (STxMP). These embodiments are generally complementary to UE embodiments summarized above.

These exemplary methods include transmitting, to the UE, DCI scheduling PUSCH transmission of a first number of layers (L1) associated with a first SRS resource set and of a second number of layers (L2) associated with a second SRS resource set. A rank of the PUSCH transmission is equal to a sum (L1+L2) of the first number of layers (L1) and the second number of layers (L2). Also, a value in a field in the DCI indicates the following:
L1 demodulation reference signal, DMRS, ports of a first subset of DMRS ports associated with the first SRS resource set, and
L2 DMRS ports of a second subset of DMRS ports associated with the second SRS resource set; and
   The first and second subsets of DMRS ports are non-overlapping. These exemplary methods also include receiving PUSCH and DMRS from the UE according to the transmitted DCI.

In some embodiments, the first and second subsets of DMRS ports are independent of a rank associated with the first SRS resource set and a rank associated with the second SRS resource set. In some embodiments, the value of the field in the DCI indicates DMRS ports based on a table mapping the value to DMRS ports. The table is selected based on the rank of the PUSCH transmission.

In some embodiments, the UE is configured for simultaneous transmission of the first and second SRS resource sets via respective first and second antenna panels. The first subset of DMRS ports comprises DMRS port 0 and DMRS port 1, and the second subset of DMRS ports comprises DMRS port 2 and DMRS port 3.

In some of these embodiments, the rank of the PUSCH transmission is equal to 3. A first value of the field in the DCI corresponds to the first number of layers (L1) equal to 2 and the second number of layers (L2) equal to 1, with the first value of the field indicates a first entry in the selected table. Also, the first entry is mapped to DMRS ports 0 and 1 for the transmission on the L1=2 layers and to DMRS port 2 for the transmission on the L2=1 layer. Also, a second value of the field in the DCI corresponds to the first number of layers (L1) equal to 1 and the second number of layers (L2) equal to 2, with the second value of the field indicating a second entry in the selected table. Also, the second entry is mapped to DMRS port 0 for the transmission on the L1=1 layer and to DMRS ports 2 and 3 for the transmission on the L2=2 layers.

In some embodiments, the first subset of DMRS ports are mapped to resource elements of a first CDM group and the second subset of DMRS ports are mapped to resource elements of a second CDM group. In some embodiments, one or more second fields in the DCI indicate the first number of layers (L1) and the second number of layers (L2). In some of these embodiments, the one or more second fields are one of the following: one or more precoding information and number of layers fields, or one or more SRS resource indicator fields.

In some embodiments, these exemplary methods also include transmitting, to the UE, an SRS configuration configuring the first and second SRS resource sets. Each SRS resource set includes one or more SRS resources, and each SRS resource is associated with one or more SRS ports. In some of these embodiments, these exemplary methods also include receiving SRS resources of the first and second SRS resources sets from respective first and second UE antenna panels, in accordance with the SRS configuration.

In some embodiments, the L1 DMRS ports are associated with a first TRP of the RAN node and the L2 DMRS ports are associated with a second TRP of the RAN node. The PUSCH and DMRS are received simultaneously via the first and second TRPs. Each TRP receives PUSCH and DMRS transmitted via a corresponding UE antenna panel.

Other embodiments include UEs (e.g., STxMP UEs) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein provide flexible and efficient techniques that avoid DMRS port collisions (i.e., with other UEs served by the same TRP) when performing rank adaption for a STxMP UE, thereby maintaining full UL capacity for MU-MIMO. Likewise, embodiments avoid network signaling that would otherwise be needed to address DMRS port collisions. Embodiments also facilitate efficient signaling for STxMP UEs by use of a single DMRS port indication (e.g., “antenna ports” field in DCI). These advantages and/or improvements can lead to improved UE UL performance in a RAN (e.g., NG-RAN, E-UTRAN), such as increased UL data rates.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary 5G/NR network architecture.

FIG. 2 shows exemplary NR UP and CP protocol stacks.

FIG. 3 shows an exemplary time-frequency resource grid for an NR slot.

FIG. 4 shows an exemplary ASN.1 data structure for an SRS-Resource information element (IE).

FIG. 5 shows an example SRS resource allocation in time and frequency within a slot.

FIG. 6 shows an exemplary ASN.1 data structure for an SRS-ResourceSet IE.

FIG. 7 shows an exemplary ASN.1 data structure for an DMRS-UplinkConfig IE.

FIGS. 8A-F show various DMRS arrangements in a resource block (RB).

FIG. 9 shows an exemplary UE with three antenna panels oriented in different directions.

FIGS. 10-11 show two exemplary scenarios in which an STxMP-capable UE is transmitting concurrently to two different TRPs.

FIGS. 12-13 show two exemplary scenarios in which an STxMP-capable UE is transmitting concurrently to two different TRPs, according to various embodiments of the present disclosure.

FIG. 14 shows a flow diagram of an exemplary method for a UE (e.g., wireless device), according to various embodiments of the present disclosure.

FIG. 15 shows a flow diagram of an exemplary method for a RAN node (e.g., base station, eNB, gNB, ng-eNB, etc.), according to various embodiments of the present disclosure.

FIG. 16 shows a communication system according to various embodiments of the present disclosure.

FIG. 17 shows a UE according to various embodiments of the present disclosure.

FIG. 18 shows a network node according to various embodiments of the present disclosure.

FIG. 19 shows host computing system according to various embodiments of the present disclosure.

FIG. 20 is a block diagram of a virtualization environment in functions implemented by some embodiments of the present disclosure may be virtualized.

FIG. 21 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, JAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

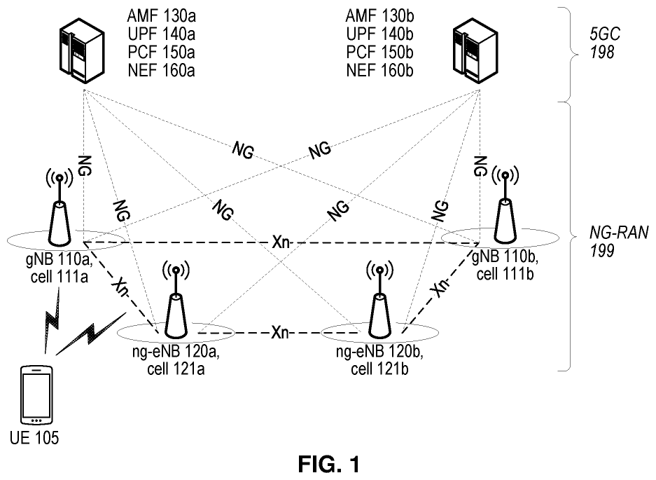

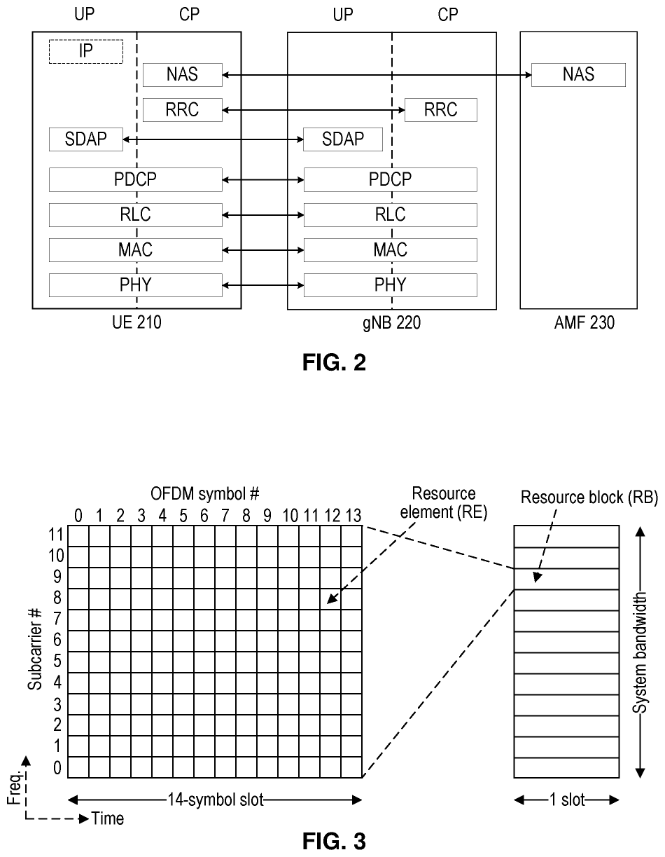

FIG. 2 shows an exemplary configuration of NR user plane (UP) and control plane (CP) protocol stacks between a UE (210), a gNB (220), and an AMF (230), such as those shown in FIG. 1. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the LE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

In 3GPP Release-15 (Rel-15), an NR UE can be configured with up to four carrier bandwidth parts (BWPs) in the DL with a single DL BWP being active at a given time. A UE can be configured with up to four BWPs in the UL with a single UL BWP being active at a given time. If a UE is configured with a supplementary UL (SUL), the UE can be configured with up to four additional BWPs in the SUL, with a single SUL BWP being active at any time.

Common RBs (CRBs) are numbered from 0 to the end of the carrier bandwidth. Each BWP configured for a UE has a common reference of CRBO, such that a configured BWP may start at a CRB greater than zero. CRBO can be identified by one of the following parameters provided by the network, as further defined in 3GPP TS 38.211 section 4.4:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. Within a BWP, PRBs are defined and numbered in the frequency domain from 0 to

$${N}_{BWP , i}^{size} - 1 ,$$

where i is the index of the BWP of the carrier.

NR supports various SCS values Δf=(15×2^{μ}) kHz, where μ∈(0, 1, 2, 3, 4) are referred to as “numerologies.” Numerology μ=0 (i.e., Δf=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is directly related to numerology according to 2^{μ}*50 MHz. Different DL and UL numerologies can be configured by the network.

FIG. 3 shows an exemplary time-frequency resource grid for an NR slot. As illustrated in FIG. 3, a resource block (RB) consists of a group of 12 contiguous OFDM subcarriers for a duration of a 14-symbol slot. Like in LTE, a resource element (RE) consists of one subcarrier in one symbol. An NR slot can include 14 OFDM symbols for normal cyclic prefix and 12 symbols for extended cyclic prefix.

In general, an NR physical channel corresponds to a set of REs carrying information that originates from higher layers. Downlink (DL, i.e., RAN node to UE) physical channels include Physical Downlink Shared Channel (PDSCH), Physical Downlink Control Channel (PDCCH), and Physical Broadcast Channel (PBCH). Uplink physical channels include Physical Uplink Shared Channel (PUSCH), Physical Uplink Control Channel (PUCCH), and Physical Random-Access Channel (PRACH). PUSCH is the uplink counterpart to the PDSCH. PUCCH is used by UEs to transmit uplink control information (UCI) including HARQ feedback for RAN node DL transmissions, channel quality feedback (e.g., CSI) for the DL channel, scheduling requests (SRs), etc. PRACH is used for random access preamble transmission.

PDSCH is the main physical channel used for unicast DL data transmission, but also for transmission of random access response (RAR), certain system information blocks (SIBs), and paging information. PBCH carries the basic system information (SI) required by the UE to access a cell. PDCCH is used for transmitting DL control information (DCI) including scheduling information for DL messages on PDSCH, grants for UL transmission on PUSCH, and channel quality feedback (e.g., CSI) for the UL channel.

PDCCH is confined to a region containing a particular number of symbols and a particular number of subcarriers, referred to as the control resource set (CORESET). A CORESET can include one or more RBs (i.e., multiples of 12 REs) in the frequency domain and 1-3 OFDM symbols in the time domain. For example, the CORESET can be in the first two symbols in a DL slot and each of the other 12 symbols contains PDSCH. Depending on the CORESET configuration, however, the first two symbols can also carry PDSCH or other information, as required.

The smallest unit used for defining CORESET is resource element group (REG), which spans one RB (i.e., 12 REs) in frequency and one OFDM symbol in time. CORESET resources can be indicated to a UE by RRC signaling. In addition to PDCCH, each REG in a CORESET contains DMRS to aid in the estimation of the radio channel over which that REG was transmitted. An NR control channel element (CCE) consists of six REGs, which may be contiguous or distributed in frequency.

NR data scheduling can be performed dynamically, e.g., on a per-slot basis. In each slot, the gNB transmits DL control information (DCI) over PDCCH that indicates which RRC_CONNECTED UE is scheduled to receive data in that slot, as well as which RBs will carry that data. A UE first detects and decodes DCI and, if the DCI includes DL scheduling information for the UE, receives the corresponding PDSCH based on the DL scheduling information. DCI formats 1_0 and 1_1 are used to convey PDSCH scheduling. Likewise, DCI on PDCCH can include UL grants that indicate which UE is scheduled to transmit data on PUCCH in that slot, as well as which RBs will carry that data. A UE first detects and decodes DCI and, if the DCI includes an uplink grant for the UE, transmits the corresponding PUSCH on the resources indicated by the UL grant.

As briefly mentioned above, PUSCH carries UL data from UE to gNB. In NR, PUSCH transmissions can use either CB-based or NCB-based precoding. The choice is determined by the parameter txConfig configured by the network via RRC. CB-based transmission can be used for non-calibrated UEs and/or in FDD arrangements, i.e., when UL/DL reciprocity does not (or is not assumed to) exist. NCB-based transmission relies on UL/DL reciprocity and is primarily used in TDD arrangements.

UEs can transmit sounding RS (SRS) in the UL, which the gNB measures to obtain UL CSI. The gNB uses UL CSI to determine appropriate transmission/reception beams for the UE and/or to perform link adaptation based on setting transmission rank and modulation and coding scheme (MCS). The gNB can also use such UL CSI to determine multiple input multiple output (MIMO) precoding of multiple data streams (called “layers”) for DL (e.g., PDSCH) and UL (e.g., PUSCH) transmissions. SRS is configured via RRC signaling and can be updated through MAC-CE signaling (e.g., to reduce update latency), as described in more detail below.

CB-based PUSCH is enabled when xConfig is set to ‘codebook’. The following description summarizes CB-based PUSCH transmission for dynamically scheduled PUSCH with configured grant type 2.

First, the UE transmits SRS of an SRS resource set that was configured with parameter usage in the RRC SRS-Config information element (IE) set to ‘codebook’. Up to two SRS resources (i.e., for testing up to two virtualizations/beams/panels), each with up to four ports, can be configured in the SRS resource set.

Subsequently, the gNB determines a number of layers (or rank) and a preferred precoder (identified by a transmit precoder matrix indicator, TPMI) from a codebook subset based on the received SRS from one of the SRS resources. The codebook subset is configured via RRC parameter codebookSubset, based on reported UE capability, and can be either fully coherent (‘fullyAndPartialAndNonCoherent’), partially coherent (‘partialAndNonCoherent’), or non-coherent (‘nonCoherent’).

Subsequently, the gNB sends the UE downlink control information (DCI) that indicates the number of layers and TPMI. The number of DCI bits used to indicate number of layers (if transform precoding is enabled, the number of PUSCH layers is limited to 1) and the TPMI is determined based on Tables 1-4 below according to the following (unless UL full-power transmission is configured, for which the number of bits may vary):
4, 5, or 6 bits if the number of antenna ports is 4, if transform precoding is disabled, and if the higher-layer parameter maxRank in PUSCH-Config IE is set to 2, 3, or 4 (see Table 1).
2, 4, or 5 bits if the number of antenna ports is 4, if transform precoding is disabled or enabled, and if the higher-layer parameter maxRank in PUSCH-Config IE is set to 1 (see Table 2).
2 or 4 bits if the number of antenna ports is 2, if transform precoding is disabled, and if the higher-layer parameter maxRank in PUSCH-Config IE is set to 2 (see Table 3).
1 or 3 bits if the number of antenna ports is 2, if transform precoding is disabled or enabled, and if the higher-layer parameter maxRank in PUSCH-Config IE is set to 1 (see Table 4).
0 bits if 1 antenna port is used for PUSCH transmission.

TABLE 1

| | fullyAndPartialAnd- | | | | |
|---|---|---|---|---|---|
| index | NonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layer: TPMI = 12 | | | | |
| . . . | . . . | | | | |
| 47 | 1 layer: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

TABLE 2

| | fullyAndPartialAnd- | | | | |
|---|---|---|---|---|---|
| index | NonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layer: TPMI = 12 | 12-15 | reserved | | |
| . . . | . . . | | | | |
| 27 | 1 layer: TPMI = 27 | | | | |
| 28-31 | reserved | | | | |

TABLE 3

| index | fullyAndPartialAndNonCoherent | index | nonCoherent |
|---|---|---|---|
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

TABLE 4

| index | fullyAndPartialAndNonCoherent | index | nonCoherent |
|---|---|---|---|
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

For a given number of layers, the TPMI field indicates a precoding matrix that UE should use for PUSCH. For example, if the number of antenna ports is 4, the number of layers is 1, and transform precoding is disabled, then the set of possible precoding matrices is shown in Table 5 below. In a second example, if the number of antenna ports is 4, the number of layers is 4, and transform precoding is disabled then the set of possible precoding matrices is shown in Table 6 below.

TABLE 5

| TPMI | W | | | | | | | |
|---|---|---|---|---|---|---|---|---|
| index | (Ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6

| TPMI | W | | | |
|---|---|---|---|---|
| index | (Ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

NCB-based UL transmission is used for reciprocity-based UL transmission in which SRS precoding is derived at a UE based on DL CSI-RS. Specifically, the UE measures received CSI-RS and determines suitable precoder weights for SRS transmission(s), resulting in one or more (virtual) SRS ports, each corresponding to a spatial layer.

To support NCB-based UL transmissions, a UE can be configured up to four SRS resources—each with a single (virtual) SRS port—in an SRS resource set with parameter usage in RRC SRS-Config IE set to ‘nonCodebook’. The gNB measures the UL channel based on the (up to four) received SRS, selects the preferred SRS resource(s), and indicates the selected SRS resources to the UE via the SRI field in DCL. The UE uses this information to precode PUSCH with a transmission rank that equals the number of indicated SRS resources and the corresponding number of SRS ports.

SRS configuration provided by a gNB includes an SRS resource allocation (e.g., physical mapping and sequence) and the time-domain behavior (e.g., aperiodic, semi-persistent, or periodic). When aperiodic SRS transmissions are configured, the gNB also transmits an activation DCI via PDCCH that instructs the UE to transmit the configured SRS at a specified time.

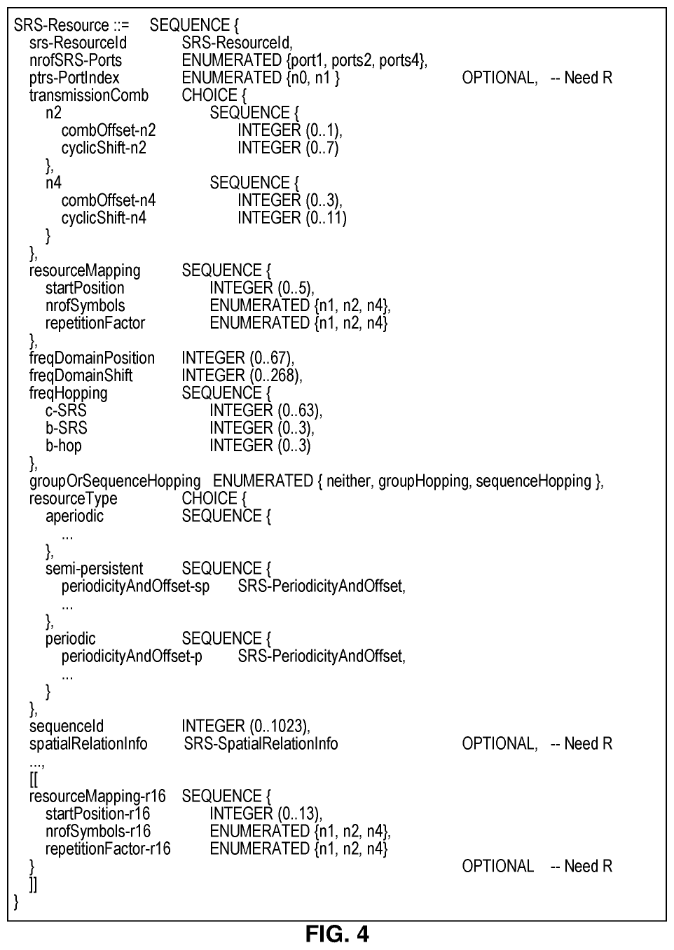

When configuring SRS transmissions, the gNB configures, through the SRS-Config IE, a set of SRS resources and a set of SRS resource sets, where each SRS resource set contains one or more SRS resources. FIG. 4 shows an exemplary ASN.1 data structure for an SRS-Resource IE, by which a gNB configures a single SRS resource. The following summarizes how specific parameters in the SRS-Resource IE configure an SRS resource:
Parameter nrofSRS-Ports configures number of SRS ports (1, 2, or 4);
Parameter transmissionComb configures the transmission comb (i.e., mapping to every 2nd or 4th subcarrier), including:
   parameter combOffset specifies which of the combs that should be used).
   parameter cyclicShift configures a (port-specific, for multi-port SRS resources) cyclic shift for the Zadoff-Chu sequence used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).
Parameter resourceMapping configures time-domain position within a given slot, including:
   parameter startPosition configures time-domain start position, which is limited to be one of the last 6 symbols (in NR Rel-15) or in any of the 14 symbols in a slot (in NR Rel-16);
   parameter nrofSymbols configures number of symbols for the SRS resource (can be set to 1, 2 or 4);
   parameter repetitionFactor configures repetition factor (can be set to 1, 2 or 4). When the repetition factor is larger than 1, the same frequency resources are used multiple times across symbols, to allow more energy to be collected by the receiver.
Sounding bandwidth, frequency-domain position and shift, and frequency-hopping pattern of an SRS resource (i.e., part of the transmission bandwidth occupied by the SRS resource) is set through parameters freqDomainPosition, freqDomainShift, and the freqHopping parameters c-SRS, b-SRS, and b-hop. The smallest possible sounding bandwidth is 4 RBs.
Parameter resourceType determines whether the SRS resource is transmitted as periodic, aperiodic (singe transmission triggered by DCI), or semi persistent (same as periodic except for the start and stop of the periodic transmission is controlled through MAC-CE signaling instead of RRC signaling).
Parameter sequenceld specifies how the SRS sequence is initialized.
Parameter spatialRelationlnfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization) as the indicated SRS resource.

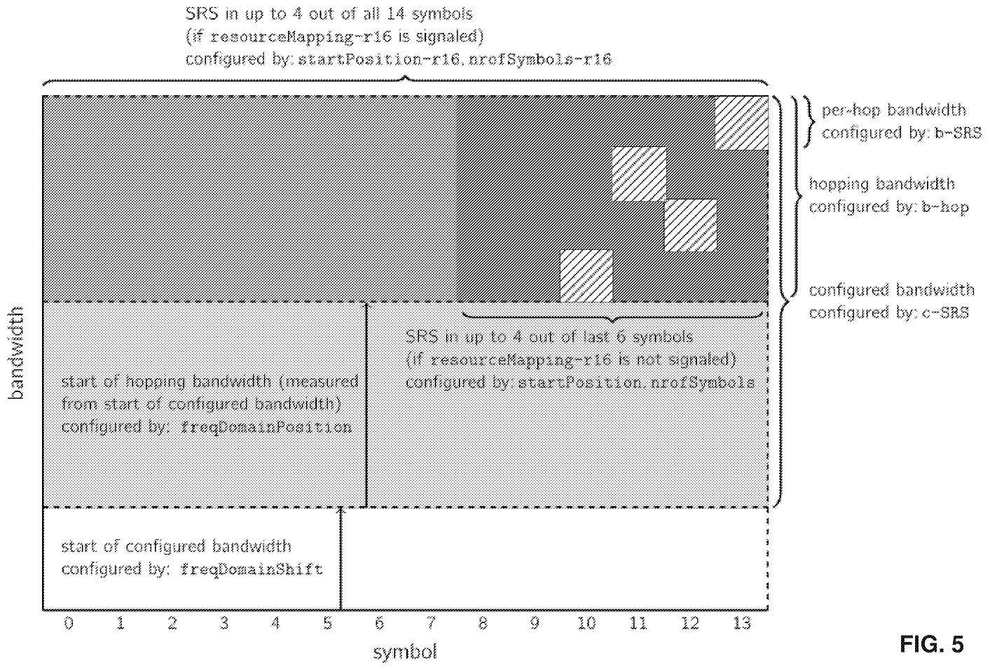

FIG. 5 shows an example allocation of an SRS resource in time and frequency within a slot. Note that semi-persistent and periodic SRS resources typically span several slots.

An optional parameter resourceMapping-r16 was introduced in Rel-16. If resourceMapping-r16 is included, the UE shall ignore the RRC parameter resourceMapping. The difference between resourceMapping-r16 and resourceMapping is that the SRS resource (for which the number of OFDM symbols and the repetition factor is limited to 4) can start in any of the 14 OFDM symbols in a slot configured by the RRC parameter startPosition-r16.

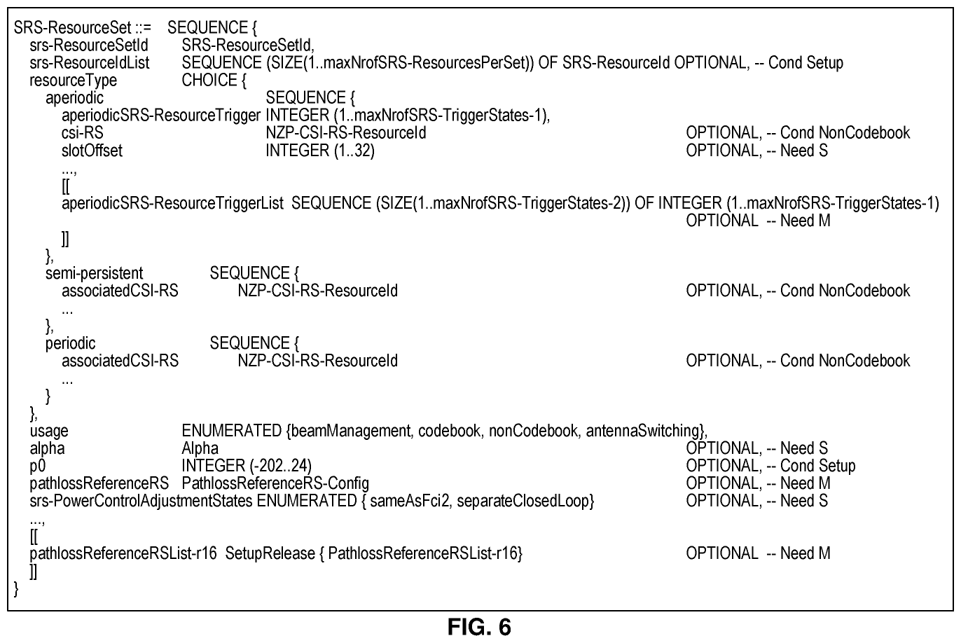

SRS resources will be transmitted as part of an SRS resource set, where all SRS resources in an SRS resource set share the same resource type. FIG. 6 shows an exemplary ASN.1 data structure for an SRS-ResourceSet IE, by which a gNB configures a single SRS resource set. The following summarizes how specific parameters in the SRS-ResourceSet IE configure an SRS resource set.

Parameter slotOffset configures the slot offset for aperiodic SRS and sets the delay from the PDCCH trigger reception to the start of the SRS transmission. Parameter usage configures the resource usage, which sets constraints and assumptions on the resource properties (as further described in 3GPP TS 38.214 v17.1.0). SRS resource sets can be configured with one of four different usages: ‘antennaSwitching’, ‘codebook’, ‘nonCodebook’ and ‘beamManagement’.

An SRS resource set configured with usage ‘antennaSwitching’ is used for reciprocity-based DL precoding, to sound the UL channel in the UL so that the gNB can use reciprocity to set a suitable DL precoders. The UE is expected to transmit one SRS port per UE antenna port.

An SRS resource set configured with usage ‘codebook’ is used for CB-based UL transmission, to sound the different UE antennas and help the gNB to determine a suitable UL precoder, transmission rank, and MCS for PUSCH transmission. There are up to two SRS resources in an SRS resource set with usage ‘codebook’. How SRS ports are mapped to UE antenna ports is, however, up to UE implementation and not known to the gNB.

An SRS resource set configured with usage ‘nonCodebook’ is used for NCB-based UL transmission. The UE transmits one SRS resource per candidate beam, with suitable candidate beams determined by the UE based on CSI-RS measurements in the DL and an assumption of reciprocity. Based measuring these, the gNB can select a subset and indicate which corresponding UL beam(s) the UE should use for PUSCH transmission. The UE will transmit one layer per indicated SRS resource. Note that UE mapping of SRS ports to antenna ports is implementation-specific and unknown to the gNB.

An SRS resource set configured with usage ‘beamManagement’ is used to evaluate different UE beams for analog beamforming arrays, mainly for frequency bands above 6 GHz (i.e., FR2). The UE transmits one SRS resource per analog beam. The gNB performs an RSRP measurement per transmitted SRS resource and, in this way, determines a suitable UE beam reports it to the UE. It is expected that the gNB configures one SRS resource set with usage ‘beamManagement’ for each analog array (i.e., panel) that the UE has.

For NCB-based UL transmission, the associated CSI-RS is set for each of the possible resource types. For an aperiodic SRS, the associated CSI-RS resource is set by the RRC parameter csi-RS. For semi-persistent/periodic SRS, the associated CSI-RS resource is set by the RRC parameter associatedCSI-RS.

Power control (PC) parameters alpha and p0 set the SRS transmission power. SRS has its own UL PC scheme in NR, which specifies how the UE should split its available output power between two or more SRS ports during a time window within a slot where SRS transmission is performed (called “SRS transmit occasion”). This scheme is further described in 3GPP TS 38.213 v17.1.0.

To summarize, the SRS-ResourceSet IE configures usage, power control, and slot offset for aperiodic SRS. The SRS-Resource IE configures allocation in time and frequency allocation, periodicity and offset, sequence, and spatial-relation information.

UEs also transmit UL DMRS associated with PUSCH. UL DMRS is a pseudo-random QPSK sequence for CP-OFDM or a low peak-to-average-power ratio (PAPR) sequence for DFT-S-OFDM. UL DMRS facilitates gNB demodulation of PUSCH, particularly in time-varying and frequency-selective channels. DMRS is confined to the scheduled PUSCH bandwidth and duration, but the mapping of DMRS to REs is configurable in frequency and time domains (e.g., via radio resource control, RRC, signaling).

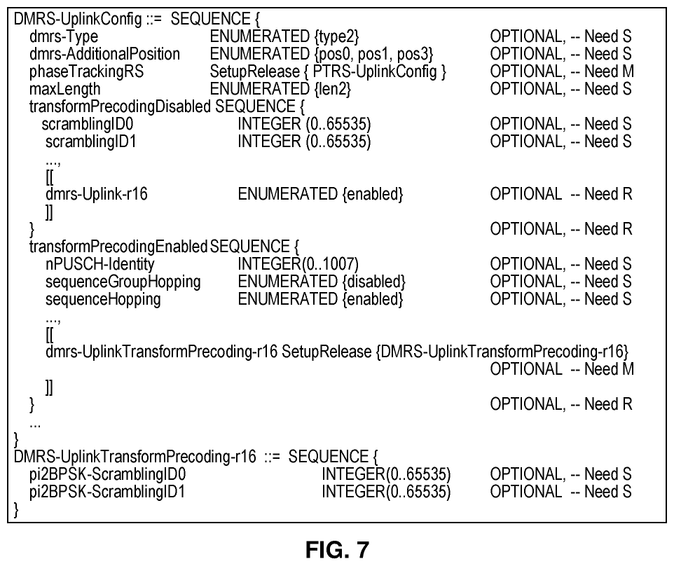

FIG. 7 shows an exemplary ASN.1 data structure for an RRC DMRS-UplinkConfig IE, by which a gNB can configure PUSCH DMRS for a UE. Particularly, this IE is used to configure DMRS for PUSCH scheduled by DCI format 0_1 or DCI format 0_2.

There are two mapping types in the frequency domain: type 1 (comb based with two CDM groups) or type 2 (non-comb based with three CDM groups). This is configured by the parameter dmrs-Type in FIG. 6. For DFT-S-OFDM, only type 1 is supported.

In the time-domain, DMRS can be either single symbol or double symbol (i.e., in pairs of two adjacent symbols). Furthermore, a UE can be configured with 1-4 single-symbol DMRS and one or two double-symbol DMRS. A single DMRS symbol may be sufficient in low-Doppler channels while additional DMRS symbols are required in higher-Doppler channels.

As briefly mentioned above, an “antenna port” is a 3GPP-defined abstraction of one or more physical antenna elements used to transmit a signal and any beamforming applied to these elements for the transmission. For example, even if two signals are transmitted using the same physical antenna elements, they will correspond to different antenna ports if they are beamformed differently (e.g., with different weights), since the beamforming will cause the signals to experience different channels.

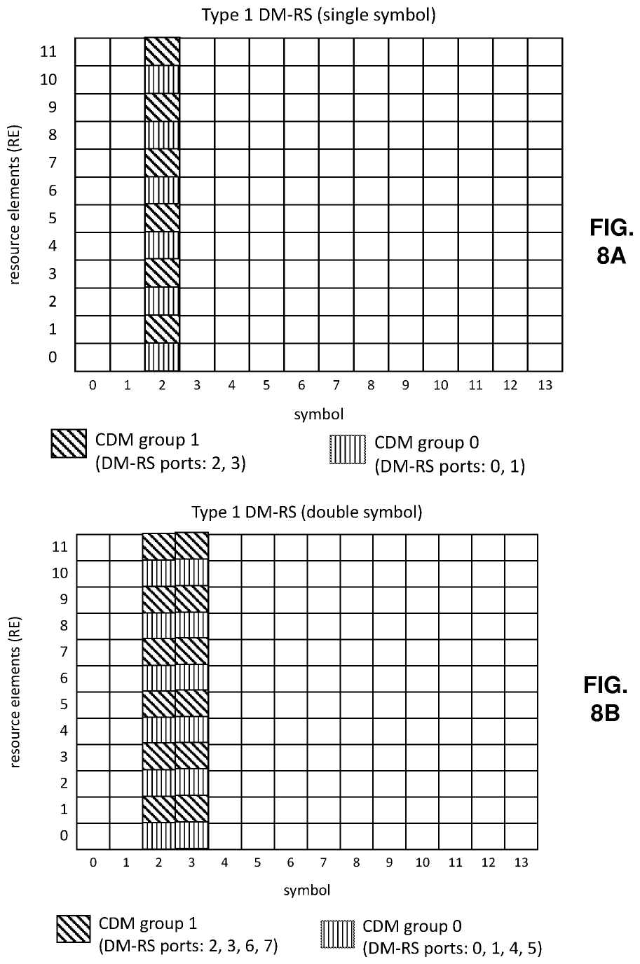

DMRS associated with PUSCH are configured according to antenna ports (or “DMRS ports”). DMRS ports are mapped to REs in a single CDM group, and different DMRS ports mapped to the same CDM group are separated (or distinguished) by a length-2 frequency domain (FD) orthogonal cover code (OCC) and, in the case of double symbol DMRS, a time-domain (TD) OCC. FIG. 8 shows the following variants of DMRS configurations in an RB:
FIG. 8A: type-1 single-symbol, 2 CDM groups, 2 DMRS ports per CDM group;
FIG. 8B: type-1 double-symbol, 2 CDM groups, 4 DMRS ports per CDM group;
FIG. 8C: type-2 single-symbol, 3 CDM groups, 2 DMRS ports per CDM group; and
FIG. 8D: type-2 double-symbol, 3 CDM groups, 4 DMRS ports per CDM group.

The frequency-domain starting position of DMRS is the same as the frequency-domain starting position of PUSCH, while the time-domain starting position of DMRS depends on the PUSCH mapping type. For PUSCH mapping type A (slot-based scheduling), the first DMRS symbol is in the third or fourth symbol of a slot (i.e., symbol index 2 or 3, starting from 0 at beginning of slot), and is configured by higher-layer parameter dmrs-TypeA-Position in the master information block (MIB) broadcast in a cell. For PUSCH mapping type B (non-slot-based scheduling), the first DMRS symbol of a slot is the same as the first PUSCH symbol of a slot. The maximum number of adjacent DMRS symbols (i.e., 1 or 2), is configured by the parameter maxLength in FIG. 7.

Any additional DMRS symbols configured by the RRC parameter dmrs-AdditionalPosition, which can be 0-3 for single-symbol DMRS and 0-1 for double-symbol DMRS. The position of additional DMRS depends on the PUSCH mapping type and PUSCH duration according to a predefined table. Note that it is not possible to configure a TD-OCC over additional DMRS in noncontiguous symbols. FIG. 8E shows an example in which one additional symbol of DMRS has been added to the configuration shown in FIG. 8A, while FIG. 8F shows an example where two additional symbols of DMRS have been added to the configuration shown in FIG. 8B.

If transform precoding is disabled (i.e., CP-OFDM waveform), DMRS for PUSCH can be additionally and optionally configured with respect to scrambling ID 0 and 1, configured by RRC parameters scramblingID0 and scramblingID1, respectively, which are used for generating the pseudo-random DMRS sequence.

In NR Rel-16, the DMRS sequence is mapped to the following subcarriers (for DFT-S-OFDM, only DMRS type 1 is supported):

$$k = \{ \begin{matrix}4 n + 2 {k}^{′} + Δ , & for type 1 , \\ 6 n + {k}^{′} + Δ , & for type 2.\end{matrix}$$

where k is the subcarrier index (which starts/ends at the first/last subcarrier within the scheduled PUSCH bandwidth), n∈{0, 1, 2, . . . }, k′∈{0, 1}, and Δ is an offset that depends on the CDM group.

Tables 7-8 below show port-specific parameters for DMRS types 1 and 2, respectively. In these tables, w_{f}(k′) is an FD-OCC corresponding to index k′, where k′∈{0,1}; and wₜ(l′) is a TD-OCC corresponding to index l′, where l′=0 for single-symbol DMRS and l′∈{0,1} for double-symbol DMRS. Note that DMRS ports in different CDM groups are separated by different offsets and that DMRS ports within the same CDM group are separated through coding.

TABLE 7

| | |
|---|---|
| w_{f} (k′) | wₜ (l′) |

| | CDM group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 8

| | |
|---|---|
| w_{f} (k′) | wₜ (l′) |

| | CDM group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

From the UE's perspective, the number of DMRS ports used for PUSCH transmission coincides with the transmission rank, i.e., one DMRS port per layer transmitted on PUSCH. DMRS port mapping is signaled to the UE via DCI, e.g., in an “antenna ports” field. This field is 2-5 bits in length, depending on DMRS type, maximum UE supported rank (indicated by UE capability signaling), and whether single- or double-symbol DMRS is configured. The “antenna ports” field also indicates the number of CDM groups that are not allocated for PDSCH or PUSCH and the number of front-loaded DMRS symbols. In contrast to DCI scheduling PDSCH, in DCI scheduling PUSCH the number of layers is indicated separately from DMRS ports.

Table 9 shows a mapping between values of the “antenna ports” field in a DCI format 0_1 and these parameters, specifically for the case of CP-OFDM, single-symbol DMRS type 1, and transmission rank 1. Table 10 shows a mapping between values of the “antenna ports” field in a DCI format 0_1 and these parameters, specifically for the case of CP-OFDM, single-symbol DMRS type 1, and transmission rank 2. Similar tables can be found in 3GPP 38.212 (v17.2.0) for transmission ranks 3-4, for double-symbol DMRS, and for DMRS type 2. Subcarriers, that are associated with a CDM group, but not used for DMRS, can be used for PUSCH. After layer mapping, the DMRS and the associated PUSCH are mapped to physical antennas through precoding.

TABLE 9

| | Number of DMRS CDM | DMRS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 10

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

For UEs, it can be beneficial and/or necessary to have the capability of receiving and transmitting in many different directions. As such, it is beneficial to have a UE antenna implementation that can generate nearly omni-directional coverage as well as narrow, high-gain beams to compensate for poor propagation conditions at high (e.g., millimeter wave, mmW) frequencies. One possible implementation is multiple UE antenna panels oriented in different directions.

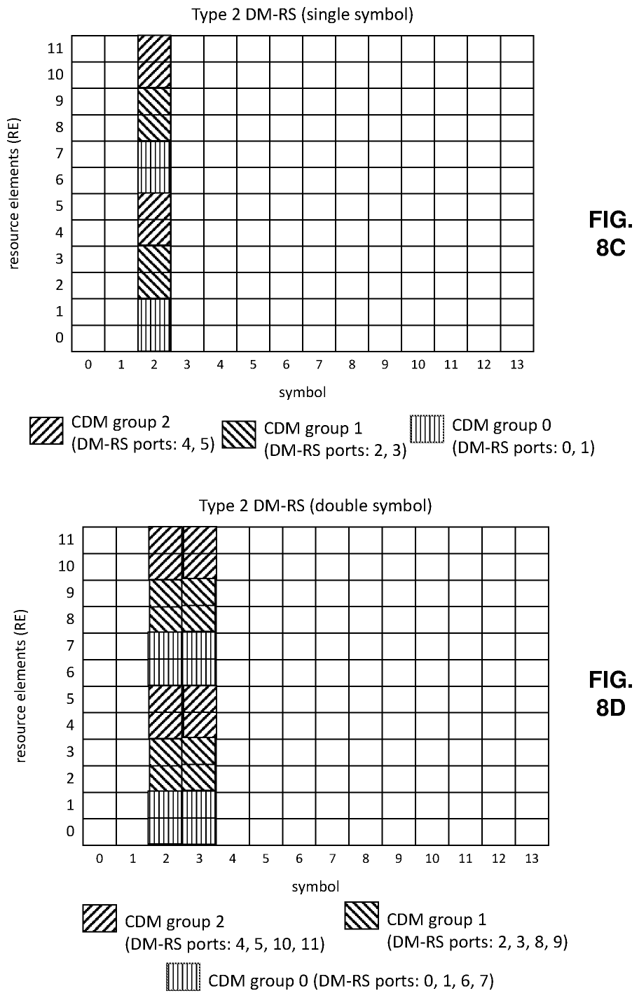

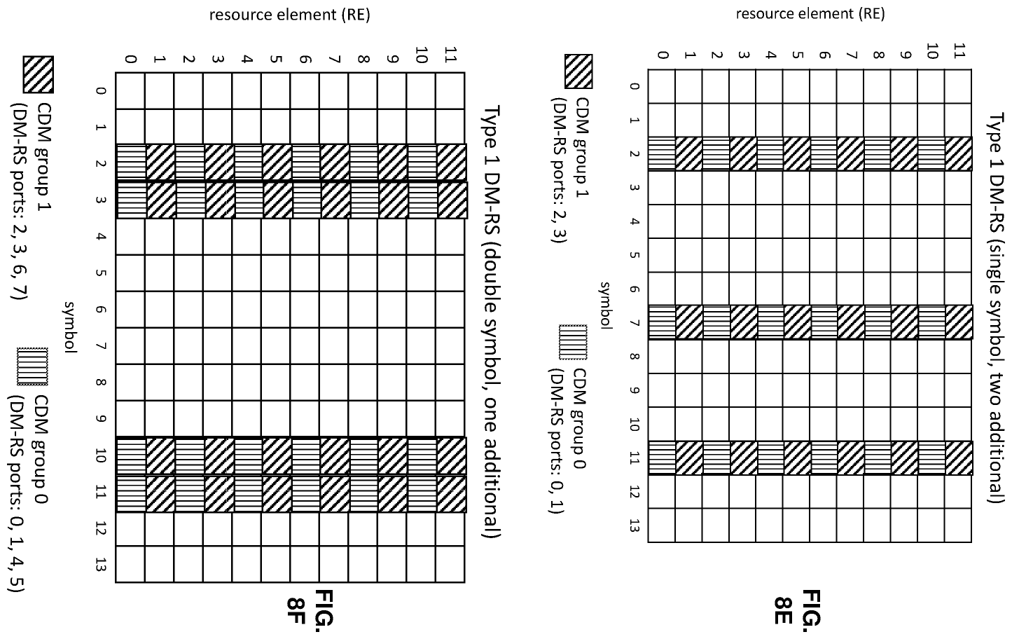

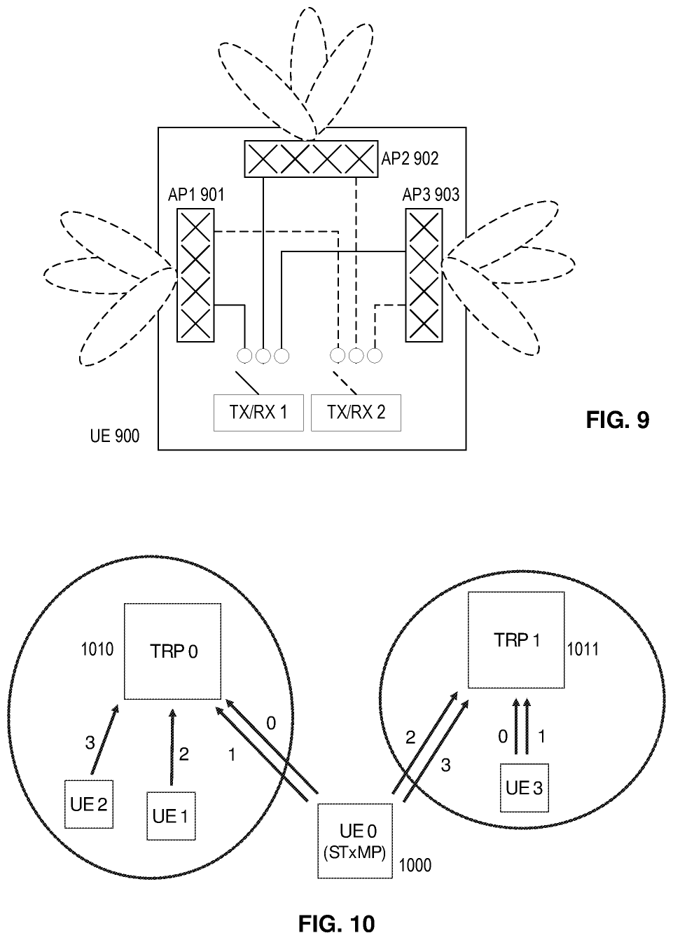

FIG. 9 shows an exemplary UE (900) with three antenna panels (AP1-3) that are oriented in different directions. Each AP includes eight antenna elements split into two groups of four antenna elements, with the elements in each group having the same polarization but a different polarization than elements of the other group. The UE includes two radio transceivers (TX/RX 1-2), with each transceiver being connectable to any one of AP1-3 at any given time. More specifically, TX/RX 1 can connect to one group of antenna elements in each of AP1-3, while TX/RX 2 can connect to the other group of antenna elements in each of AP1-3. When connected to the four antenna elements in a group, a transceiver can generate TX/RX beams based on beamforming techniques.

Conventionally, it has been left to UE discretion to choose one or more of its antenna panels for an UL transmission. 3GPP Rel-18 includes a study on simultaneous multi-panel transmission (STxMP), with a goal of the RAN (e.g., serving gNB) having the ability to schedule a UE UL transmission across multiple UE antenna panels, with the transmissions from the multiple panels being intended for the same TRP or different TRPs.

Specifically, the Rel-18 work has an objective to study, and if needed, specify various items to facilitate simultaneous multi-panel UL transmission for higher UL throughput/reliability. The study should focus on FR2, up to 2 TRPs, and up to 2 antenna panels, and should target applications such as customer premises equipment (CPE), fixed wireless access (FWA), vehicles, industrial devices, etc. The items to be studied/specified include:
UL precoding indication for PUSCH, where no new codebook is introduced for multi-panel simultaneous transmission, with ≤4 total layers and ≤2 total codewords across all panels, and with either single- or multi-DCI based operation for multi-TRP.
UL beam indication for PUCCH/PUSCH, where a unified TCI framework extension is assumed, and with either single- or multi-DCI based operation for multi-TRP. For the case of multi-DCI based multi-TRP operation, only PUSCH+PUSCH or PUCCH+PUCCH is transmitted across two panels in a single component carrier (CC).

The following agreements related to STxMP have been reached in 3GPP in the context of this study work:
Study the enhancement of SRS resource set configuration and SRI/TPMI indication for single-DCI based STxMP PUSCH scheme:
   Starting point: configuration of two SRS resource sets, SRS resource set indicator field, two SRI fields, and two TPMI fields of Rel-17 mTRP PUSCH TDM repetition.
   For further study (FFS): The configuration of one SRS resource set, one or two SRI fields and one or two TPMI fields
   This does not mean that any possible SRI/TPMI enhancement on STxMP would be precluded. In RAN1 #110, companies can suggest the detail SRI/TPMI enhancement with reasonable analysis and evaluation result.
Study the layer combinations of {1+1, 1+2, 2+1, 2+2} for the SDM scheme (if supported) of single-DCI based STxMP PUSCH,
   For ≥1 codeword.
   Layer combination for SDM scheme can be further studied for two codewords, if SDM scheme supports two codewords.
   FFS: layer combinations of {1+3, 3+1} under the above conditions.
Study if any enhancement is needed on DMRS port indication for SDM scheme (if supported) of single-DCI based STxMP PUSCH. It is FFS how to map DMRS ports to two joint/UL TCI states/codewords/panels/TRPs/SRS resource sets/PUSCH layers for CB-based and non-CB-based PUSCH.

As noted above, the Rel-18 study has not determined how to map and/or associate DMRS ports for STxMP. One proposal is that the total number of DMRS ports and the assumed rank for DMRS port mapping (i.e., which dictates the antenna-port table to be used) should be the total number of PUSCH layers transmitted from the STxMP-capable UE (i.e., sum of layers from different antenna panels). This would be specified by a single “antenna ports” field in DCI, which would reduce DCI signaling overhead compared to multiple fields. However, it also causes various problems, issues, and/or difficulties for UEs and RAN nodes (e.g., gNBs), including in relation to UE transmission of SRS.

Consider the example of CB-based precoding, which will likely have two SRS resource sets and two SRI/TPMI fields in DCI for the STxMP use case. Let L₁ and L₂ denote the numbers of layers, transmitted from first and second UE panels, as indicated by first and second “Precoding and number of layers” fields in DCI. Thus, the total number of layers assumed for DMRS port mapping is Lₜₒₜ=L₁+L₂. As explained in more detail below, one problem is that the DMRS ports assigned to a second set of antenna ports (SRS ports) for an STxMP UE will depend on the transmission rank used at a first set of antenna ports (SRS ports) of the same STxMP UE. This makes it challenging to co-schedule STxMP UEs with other UEs in a MU-MIMO system.

FIG. 10 shows an exemplary scenario in which an STxMP UE (UE0) is transmitting concurrently to two different TRPs (TRP0 and TRP1). In this scenario, UE0 is transmitting with rank 4 (i.e., four layers), split evenly over two sets of antenna ports such that Lₜₒₜ '₂ 2+2=4. In this example, the UE is configured with single-symbol type-1 DMRS with ports 0-3 according to 3GPP TS 38.212 (v17.2.0) Table 7.3.1.1.2-11 that applies to rank-4 transmission (repeated below as Table 11).

TABLE 11

| | Number of DMRS CDM | DMRS |
|---|---|---|
| Value | group(s) without data | port(s) |
| 0 | 2 | 0-3 |
| 1-7 | Reserved | Reserved |

Ports 0-1 (L₁=2) are assigned to TRP0 and ports 2-3 (L₂=2) are assigned to TRP1. This assignment is illustrated by the numerals adjacent to the UL arrows. DMRS ports 0-1 (L₁=2) map to SRS ports associated with a first SRS resource (indicated by a first TPMI/SRI) and t DMRS ports 2-3 (L₂=2) map to SRS ports associated with a second SRS resource (indicated by a second TPMI/SRI).

As shown in FIG. 10, only two of four available DMRS ports for each TRP are occupied by the STxMP UE, such that the remaining DMRS ports can be used by other UEs in a MU-MIMO scenario. For example, DMRS port 2-3 can be used by UEs 1-2 served by TRP0 and DMRS ports 0-1 can be used by UE3 served by TRP1.

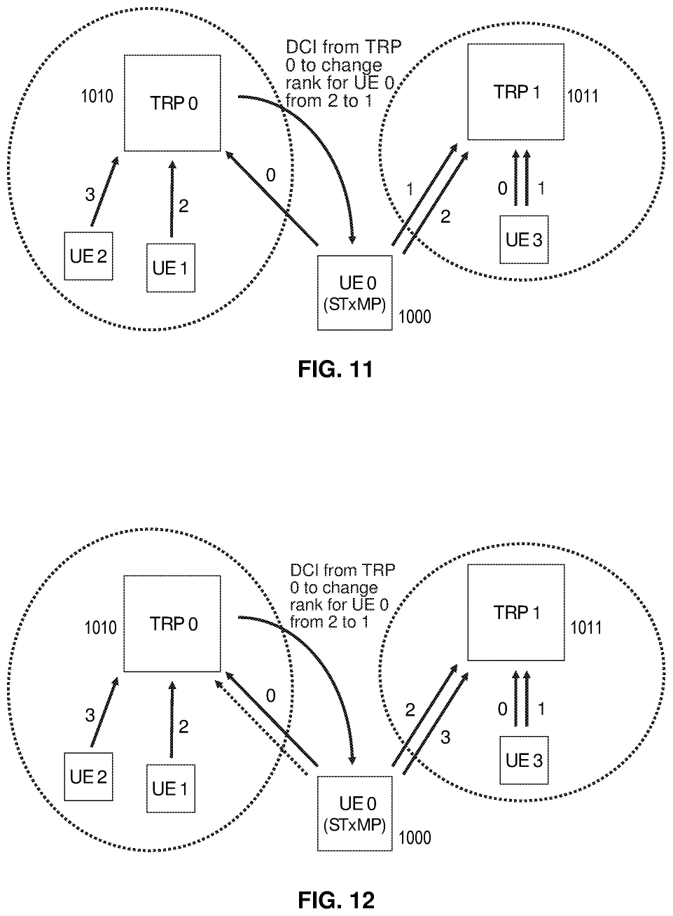

FIG. 11 shows another exemplary scenario in which the STxMP UE (UE0) is transmitting concurrently to TRP0 and TRP1. In this scenario, UE0 is transmitting with rank 3 (i.e., three layers), with L₂=2 for TRP1 and L₁=1 for TRP0. For example, the scenario shown in FIG. 11 can result from UE0 receiving a DCI from TRP0 that changes the rank from 2 (as in FIG. 10) to 1. If the UE is still configured with single-symbol type-1 DMRS as in FIG. 10, the UE must use DMRS ports 0-2 according to 3GPP TS 38.212 (v17.2.0) Table 7.3.1.1.2-10 that applies to rank-3 transmission (repeated below as Table 12).

TABLE 12

| | Number of DMRS CDM | DMRS |
|---|---|---|
| Value | group(s) without data | port(s) |
| 0 | 2 | 0-2 |
| 1-7 | Reserved | Reserved |

In this case, DMRS port 0 is assigned to TRP0 (L₁=1) and DMRS ports 1-2 are assigned to TRP1 (L₂₌₂). However, this assignment is problematic because DMRS port 1 in TRP1 is already being used by UE 3, i.e., in MU-MIMO arrangement. This DMRS port collision can reduce UL throughput in TRP1 for both UE0 and UE3.

To summarize, dynamic rank adaption for STxMP UEs—such as illustrated in FIGS. 10-11—can cause DMRS collision in a MU-MIMO system. If this situation is avoided by not using the colliding DMRS ports, the result is reduced UL throughput and/or capacity.

Accordingly, embodiments of the present disclosure provide flexible and efficient techniques for DMRS port assignment for STxMP UEs transmitting to multiple TRPs in a RAN, particularly when used with dynamic rank adaptation for UL transmissions (e.g., PUSCH). In various embodiments, an STxMP UE can receive from a RAN node an indication of which DMRS ports to use for UL transmissions to multiple TRPs (e.g., associated with the RAN node), such as in an “antenna ports” field of a DCI. In some embodiments, the indicated number of DMRS ports is based on the total number of SRS ports transmitted by/from the STxMP UE, possibly split over multiple SRS resource sets. In some embodiments, only a subset of the possible values of the indication (e.g., “antenna ports’ field codepoints) are considered valid by the STxMP UE, such that the UE does not expect to receive the remaining values of the indication.

Embodiments can provide various benefits and/or advantages. For example, embodiments can avoid DMRS port collisions (i.e., with other UEs served by the same TRP) when performing rank adaption for a STxMP UE, thereby maintaining full UL capacity for MU-MIMO. Likewise, embodiments avoid network signaling that would otherwise be needed to address such DMRS port collisions. Embodiments also facilitate efficient signaling for STxMP UEs by use of a single DMRS port indication (e.g., “antenna ports” field in DCI).

The following description is based on an “antenna ports” field in DCI as a specific type of indication. For example, 3GPP TS 38.212 (v) clause 7.3.1.1.2 includes various tables that define the content of “antenna ports” field of DCI format 0_1. Even so, this is merely an example and any other appropriate type of indication can be used to convey the described information.

In some embodiments, the total number of DMRS ports Lₜₒₜ in the “antenna ports” field in DCI is given by the total number of SRS ports that can be signaled in one DCI. Specifically, let S₁ denote the number of SRS ports in a first SRS resource set and let S₂ denote the number of SRS ports in a second SRS resource set, then Lₜₒₜ=S₁+S₂. Note that Sₘ≥Lₘ, m=1,2, where Lₘ is the number of layers.

For CB-based operation, assuming dual TPMIs for STxMP, the number of layers Lₘ, m=1,2, can be indicated by the mth “precoding and number of layers” field in DCI. For NCB-based operation, assuming dual SRS resource sets and SRIs for STxMP, the number of layers Lₘ, m=1,2, can be indicated by the mth “SRS resource indicator” field in the DCI, which indicates the number of SRS resources.

In some embodiments, if the UE receives an indication to transmit fewer layers than the number of SRS ports (i.e., Lₘ≤Sₘ for any m≥1), the UE uses DMRS ports 0 to (L₁−1) for the layers corresponding to SRS resource set 1, DMRS ports S₁ to S₁+(L₂−1) for the layers corresponding to SRS resource set 2, DMRS ports S₁+S₂ to S₁+S₂+(L₃−1) for the layers corresponding to SRS resource set 3, etc. In other words, non-overlapping subsets of DMRS ports are used for the respective SRS resource sets.

Table 13 below shows an example of these embodiments for two SRS resource sets (i.e., m=1,2). Note that “rank (x, y)” denotes an UL transmission with rank x+y, with x layers corresponding to a first SRS resource set and y layers corresponding to a second SRS resource set. The table entries indicate DMRS ports used with the respective SRS resource sets.

TABLE 13

| | rank (1, 1) | rank (2, 1) | rank (1, 2) | rank (2, 2) |
|---|---|---|---|---|
| SRS resource set 1 | 0 | 0, 1 | 0 | 0, 1 |
| SRS resource set 2 | 2 | 2 | 2, 3 | 2, 3 |

FIG. 12 shows an exemplary scenario in which an STxMP UE is transmitting concurrently to two different TRPs, according to some embodiments of the present disclosure. In this scenario, the RAN dynamically adjusts UE0's transmission from rank(2,2) to rank(1,2), in a similar manner as described above in relation to FIG. 11. Instead of changing DMRS ports in a conventional way, which can lead to the problems discussed above, UE0 merely drops DMRS port 1 for the transmissions to TRP0 and maintains DMRS ports 2-3 for the transmissions to TRP1. This avoids the DMRS collision problems shown in FIG. 11 allows for a better utilization of DMRS ports per serving TRP.

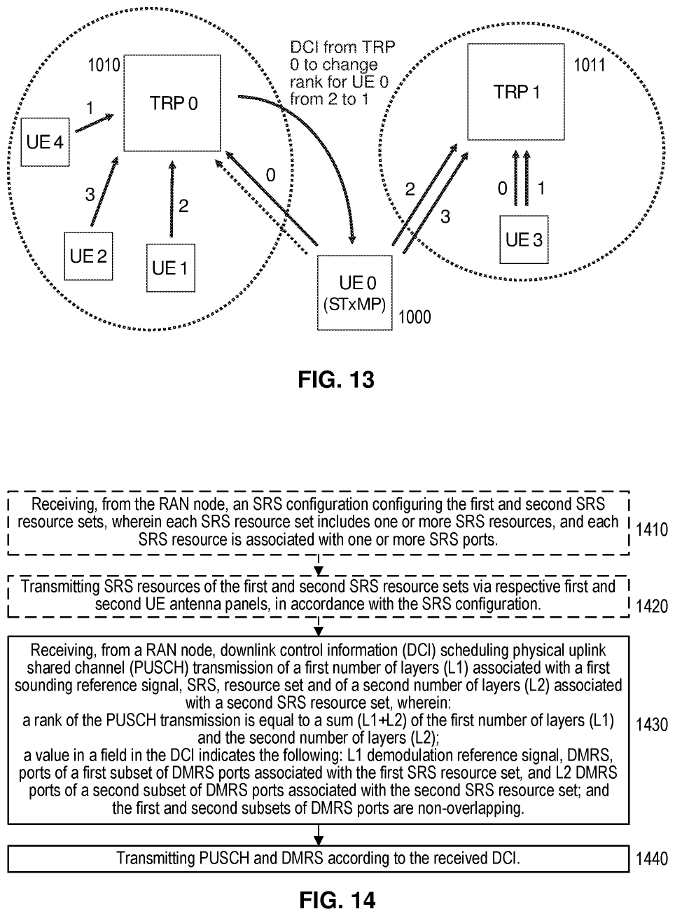

When S₁+S₂ SRS ports are used determine the number of DMRS ports in the “antenna ports” field, but L₁+L₂<S₁+S₂, the Sₘ−Lₘ unused DMRS ports on the respective TRPs can be occupied by other UEs. FIG. 13 shows an extension of the arrangement shown in FIG. 12, in which S₁−L₁=1 unused DMRS port on TRP0 is assigned to another UE (i.e., UE4). Note that there are S₂−L₂₌₀ unused DMRS ports on TRP1.

In some embodiments, when the STxMP UE has received indication to transmit fewer layers than the number of SRS ports in a corresponding SRS resource set, and the unused DMRS ports corresponding to an SRS resource set are in another CDM group than the used DMRS ports, then the STxMP UE is implicitly configured to transmit PUSCH in the other CDM group.

In some embodiments, the set of allowed values in the “antenna ports” field is restricted such that the DMRS ports per serving TRP remain unchanged after dynamic rank adaptation. In other words, only a subset of the possible values of “antenna ports’ field are considered valid by the STxMP UE, such that the UE does not expect to receive the remaining values.

Consider an example where the RAN adapts the UE from rank(2,2) to rank(1,1). Table 11 above shows the “antenna ports” values for rank(2,2) and type-1 single-symbol DMRS. In this case, DMRS ports 0-1 belong to a first SRS resource set and DMRS ports 2-3 belong to a second SRS resource set. In other words, non-overlapping subsets of DMRS ports belong to the respective SRS resource sets.

Table 10 above shows the “antenna ports” values for rank(1,1) and type-1 single-symbol DMRS. Note that there are four possible values. According to these embodiments, when the UE is adapted from rank (2,2) to rank(1,1), the UE continues to use one of DMRS ports 0-1 with TRP0 and one of DMRS ports 2-3 with TRP1. In such case, only one entry (value “3”) in Table 10 is considered valid by the UE. This is illustrated in Table 14 below, where the invalid entries from Table 10 above are indicated by strikethrough.

TABLE 14

| | Number of DMRS CDM | DMRS |
|---|---|---|
| Value | group(s) without data | port(s) |
| [symbol] | [symbol] | [symbol] |
| [symbol] | [symbol] | [symbol] |
| [symbol] | [symbol] | [symbol] |
| 3 | 2 | 0, 2 |
| 4-7 | Reserved | Reserved |

In some embodiments, new entries may be added to existing “antenna ports” tables in 3GPP TS 38.212 (v17.2.0), or other relevant specification, for a particular rank to support STxMP UEs with different rank distributions among various SRS resource sets. Table 15 below shows an example in which a new entry (corresponding to value “1”) is added to existing Table 12 (above) for rank-3 transmission. For example, the existing entry (corresponding to value “0”) can be used for rank (2,1) transmission and the new entry can be used for rank (1,2) transmission.

TABLE 15

| | Number of DMRS CDM | DMRS |
|---|---|---|
| Value | group(s) without data | port(s) |
| 0 | 2 | 0-2 |
| 1 | 2 | 0, 2-3 |
| 2-7 | Reserved | Reserved |

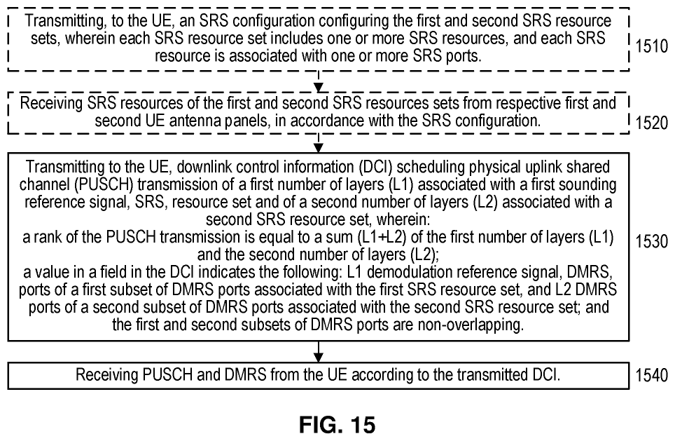

Various features of the embodiments described above correspond to various operations illustrated in FIGS. 14-15, which show exemplary methods (e.g., procedures) for a UE and a RAN node, respectively. In other words, various features of the operations described below correspond to various embodiments described above. Furthermore, the exemplary methods shown in FIGS. 14-15 can be used cooperatively to provide various benefits, advantages, and/or solutions to problems described herein. Although FIGS. 14-15 show specific blocks in particular orders, the operations of the exemplary methods can be performed in different orders than shown and can be combined and/or divided into blocks having different functionality than shown. Optional blocks or operations are indicated by dashed lines.

In particular, FIG. 14 shows an exemplary method (e.g., procedure) for a UE configured for simultaneous multi-panel transmission (STxMP), according to various embodiments of the present disclosure. The exemplary method can be performed by a UE (e.g., STxMP UE, wireless device, IoT device, etc.) such as described elsewhere herein.

The exemplary method can include the operations of block 1430, where the UE can receive, from a RAN node, downlink control information (DCI) scheduling physical uplink shared channel (PUSCH) transmission of a first number of layers (L1) associated with a first sounding reference signal (SRS) resource set and of a second number of layers (L2) associated with a second SRS resource set. A rank of the PUSCH transmission is equal to a sum (L1+L2) of the first number of layers (L1) and the second number of layers (L2). Also, a value in a field in the DCI indicates the following:
L1 demodulation reference signal, DMRS, ports of a first subset of DMRS ports associated with the first SRS resource set, and
L2 DMRS ports of a second subset of DMRS ports associated with the second SRS resource set; and
   The first and second subsets of DMRS ports are non-overlapping, some examples of which were discussed above. The exemplary method can also include the operations of block 1440, where the UE can transmit PUSCH and DMRS according to the received DCI.

In some embodiments, the first and second subsets of DMRS ports are independent of a rank associated with the first SRS resource set and a rank associated with the second SRS resource set. In other words, the first and second subsets of DMRS ports are independent of a distribution of the rank of the PUSCH transmission between layers associated with the first SRS resource set and layers associated with the second SRS resource set. Table 15 shows an example of these embodiments.

In some embodiments, the value of the field in the DCI indicates DMRS ports based on a table mapping the value of the field to DMRS ports. The table is selected based on the rank of the PUSCH transmission. Various example tables that map values of an “antenna ports” DCI field to DMRS ports were discussed above.

In some embodiments, the UE is configured for simultaneous transmission of the first and second SRS resource sets via respective first and second antenna panels. The first subset of DMRS ports comprises DMRS port 0 and DMRS port 1, and the second subset of DMRS ports comprises DMRS port 2 and DMRS port 3. This is a specific example of non-overlapping subsets of DMRS ports that was also discussed above.

In some of these embodiments, the rank of the PUSCH transmission is equal to 3. A first value of the field in the DCI corresponds to the first number of layers (L1) equal to 2 and the second number of layers (L2) equal to 1, with the first value of the field indicates a first entry in the selected table. Also, the first entry is mapped to DMRS ports 0 and 1 for the transmission on the L1=2 layers and to DMRS port 2 for the transmission on the L2=1 layer. Also, a second value of the field in the DCI corresponds to the first number of layers (L1) equal to 1 and the second number of layers (L2) equal to 2, with the second value of the field indicating a second entry in the selected table. Also, the second entry is mapped to DMRS port 0 for the transmission on the L1=1 layer and to DMRS ports 2 and 3 for the transmission on the L2=2 layers. Table 15 above shows an example of these embodiments.

In some embodiments, the first subset of DMRS ports are mapped to resource elements of a first CDM group and the second subset of DMRS ports are mapped to resource elements of a second CDM group. FIGS. 8A-F show some examples of these embodiments.

In some embodiments, one or more second fields in the DCI indicate the first number of layers (L1) and the second number of layers (L2). In some of these embodiments, the one or more second fields are one of the following: one or more precoding information and number of layers fields, or one or more SRS resource indicator fields.

In some embodiments, the exemplary method can also include the operations of block 1410, where the UE can receive, from the RAN node, an SRS configuration configuring the first and second SRS resource sets. Each SRS resource set includes one or more SRS resources, and each SRS resource is associated with one or more SRS ports. In some of these embodiments, the exemplary method can also include the operations of block 1420, where the UE can transmit SRS resources of the first and second SRS resource sets via respective first and second UE antenna panels, in accordance with the SRS configuration.

In some embodiments, the PUSCH and DMRS are transmitted simultaneously via two UE antenna panels. The L1 DMRS ports are associated with a first TRP of the RAN node and the L2 DMRS ports are associated with a second TRP of the RAN node. Each TRP is a destination for PUSCH and DMRS transmitted via a corresponding one of the two UE antenna panels.

In addition, FIG. 15 shows an exemplary method (e.g., procedure) for a RAN node configured to receive transmissions from a UE arranged for simultaneous multi-panel transmission (STxMP), according to various embodiments of the present disclosure. The exemplary method can be performed by a RAN node (e.g., base station, eNB, gNB, ng-eNB, etc., or component thereof) such as described elsewhere herein.

The exemplary method can include the operations of block 1530, where the RAN node can transmit, to the UE, DCI scheduling PUSCH transmission of a first number of layers (L1) associated with a first SRS resource set and of a second number of layers (L2) associated with a second SRS resource set. A rank of the PUSCH transmission is equal to a sum (L1+L2) of the first number of layers (L1) and the second number of layers (L2). Also, a value in a field in the DCI indicates the following:
L1 demodulation reference signal, DMRS, ports of a first subset of DMRS ports associated with the first SRS resource set, and
L2 DMRS ports of a second subset of DMRS ports associated with the second SRS resource set; and
   The first and second subsets of DMRS ports are non-overlapping, some examples of which were discussed above. The exemplary method can also include the operations of block 1540, where the RAN node can receive PUSCH and DMRS from the UE according to the transmitted DCI.

In some embodiments, the first and second subsets of DMRS ports are independent of a rank associated with the first SRS resource set and a rank associated with the second SRS resource set. In other words, the first and second subsets of DMRS ports are independent of a distribution of the rank of the PUSCH transmission between layers associated with the first SRS resource set and layers associated with the second SRS resource set. Table 15 shows an example of these embodiments.

In some embodiments, the value of the field in the DCI indicates DMRS ports based on a table mapping the value to DMRS ports. The table is selected based on the rank of the PUSCH transmission. Various example tables that map values of an “antenna ports” DCI field to DMRS ports were discussed above.

In some embodiments, the UE is configured for simultaneous transmission of the first and second SRS resource sets via respective first and second antenna panels. The first subset of DMRS ports comprises DMRS port 0 and DMRS port 1, and the second subset of DMRS ports comprises DMRS port 2 and DMRS port 3. This is a specific example of non-overlapping subsets of DMRS ports that was also discussed above.

In some of these embodiments, the rank of the PUSCH transmission is equal to 3. A first value of the field in the DCI corresponds to the first number of layers (L1) equal to 2 and the second number of layers (L2) equal to 1, with the first value of the field indicates a first entry in the selected table. Also, the first entry is mapped to DMRS ports 0 and 1 for the transmission on the L1=2 layers and to DMRS port 2 for the transmission on the L2=1 layer. Also, a second value of the field in the DCI corresponds to the first number of layers (L1) equal to 1 and the second number of layers (L2) equal to 2, with the second value of the field indicating a second entry in the selected table. Also, the second entry is mapped to DMRS port 0 for the transmission on the L1=1 layer and to DMRS ports 2 and 3 for the transmission on the L2=2 layers. Table 15 above shows an example of these embodiments.

In some embodiments, the first subset of DMRS ports are mapped to resource elements of a first CDM group and the second subset of DMRS ports are mapped to resource elements of a second CDM group. FIGS. 8A-F show some examples of these embodiments.

In some embodiments, one or more second fields in the DCI indicate the first number of layers (L1) and the second number of layers (L2). In some of these embodiments, the one or more second fields are one of the following: one or more precoding information and number of layers fields, or one or more SRS resource indicator fields.

In some embodiments, the exemplary method can also include the operations of block 1510, where the RAN node can transmit, to the UE, an SRS configuration configuring the first and second SRS resource sets. Each SRS resource set includes one or more SRS resources, and each SRS resource is associated with one or more SRS ports. In some of these embodiments, the exemplary method can also include the operations of block 1520, where the RAN node can receive SRS resources of the first and second SRS resources sets from respective first and second UE antenna panels, in accordance with the SRS configuration.

In some embodiments, the L1 DMRS ports are associated with a first TRP of the RAN node and the L2 DMRS ports are associated with a second TRP of the RAN node. The PUSCH and DMRS are received simultaneously via the first and second TRPs. Each TRP receives PUSCH and DMRS transmitted via a corresponding UE antenna panel.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

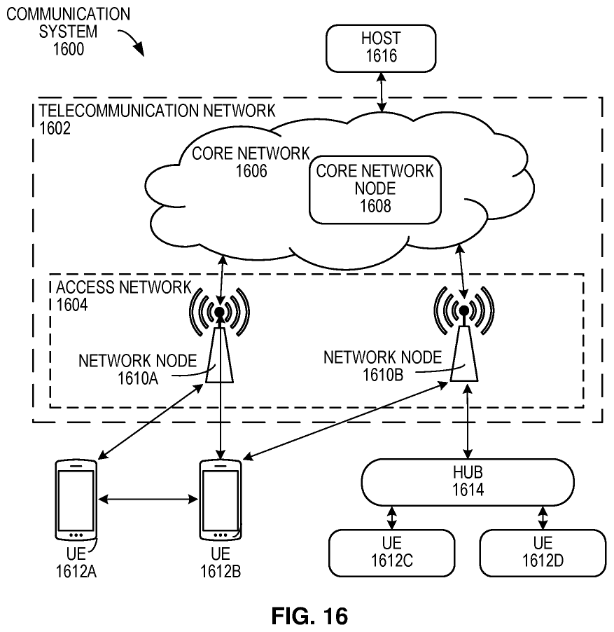

FIG. 16 shows an example of a communication system 1600 in accordance with some embodiments. In this example, communication system 1600 includes a telecommunication network 1602 that includes an access network 1604 (e.g., RAN) and a core network 1606, which includes one or more core network nodes 1608. Access network 1604 includes one or more access network nodes, such as network nodes 1610a-b (one or more of which may be generally referred to as network nodes 1610), or any other similar 3GPP access node or non-3GPP access point. Network nodes 1610 facilitate direct or indirect connection of UEs, such as by connecting UEs 1612a-d (one or more of which may be generally referred to as UEs 1612) to core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1600 may include any number of wired or wireless networks, network nodes, UEs, and/or any other components or systems that may facilitate or participate in the communication of data and/or signals whether via wired or wireless connections. Communication system 1600 may include and/or interface with any type of communication, telecommunication, data, cellular, radio network, and/or other similar type of system.

UEs 1612 may be any of a wide variety of communication devices, including wireless devices arranged, configured, and/or operable to communicate wirelessly with network nodes 1610 and other communication devices. Similarly, network nodes 1610 are arranged, capable, configured, and/or operable to communicate directly or indirectly with UEs 1612 and/or with other network nodes or equipment in telecommunication network 1602 to enable and/or provide network access, such as wireless network access, and/or to perform other functions, such as administration in telecommunication network 1602.

In the depicted example, core network 1606 connects network nodes 1610 to one or more hosts, such as host 1616. These connections may be direct or indirect via one or more intermediary networks or devices. In other examples, network nodes may be directly coupled to hosts. Core network 1606 includes one or more core network nodes (e.g., 1608) that are structured with hardware and software components. Features of these components may be substantially similar to those described with respect to the UEs, network nodes, and/or hosts, such that the descriptions thereof are generally applicable to the corresponding components of core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1616 may be under the ownership or control of a service provider other than an operator or provider of access network 1604 and/or telecommunication network 1602, and may be operated by the service provider or on behalf of the service provider. Host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1602 is a cellular network that implements 3GPP standardized features. Accordingly, the telecommunications network 1602 may support network slicing to provide different logical networks to different devices that are connected to telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1612 are configured to transmit and/or receive information without direct human interaction. For instance, a UE may be designed to transmit information to access network 1604 on a predetermined schedule, when triggered by an internal or external event, or in response to requests from access network 1604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1614 communicates with access network 1604 to facilitate indirect communication between one or more UEs (e.g., UE 1612c and/or 1612d) and network nodes (e.g., network node 1610b). In some examples, hub 1614 may be a controller, router, content source and analytics, or any of the other communication devices described herein regarding UEs. For example, hub 1614 may be a broadband router enabling access to core network 1606 for the UEs. As another example, hub 1614 may be a controller that sends commands or instructions to one or more actuators in the UEs. Commands or instructions may be received from the UEs, network nodes 1610, or by executable code, script, process, or other instructions in hub 1614. As another example, hub 1614 may be a data collector that acts as temporary storage for UE data and, in some embodiments, may perform analysis or other processing of the data. As another example, hub 1614 may be a content source. For example, for a UE that is a VR headset, display, loudspeaker or other media delivery device, hub 1614 may retrieve VR assets, video, audio, or other media or data related to sensory information via a network node, which hub 1614 then provides to the UE either directly, after performing local processing, and/or after adding additional local content. In still another example, hub 1614 acts as a proxy server or orchestrator for the UEs, in particular in if one or more of the UEs are low energy IoT devices.

Hub 1614 may have a constant/persistent or intermittent connection to network node 1610b. Hub 1614 may also allow for a different communication scheme and/or schedule between hub 1614 and UEs (e.g., UE 1612c and/or 1612d), and between hub 1614 and core network 1606. In other examples, hub 1614 is connected to core network 1606 and/or one or more UEs via a wired connection. Moreover, hub 1614 may be configured to connect to an M2M service provider over access network 1604 and/or to another UE over a direct connection. In some scenarios, UEs may establish a wireless connection with network nodes 1610 while still connected via hub 1614 via a wired or wireless connection. In some embodiments, hub 1614 may be a dedicated hub—that is, a hub whose primary function is to route communications to/from the UEs from/to network node 1610b. In other embodiments, hub 1614 may be a non-dedicated hub—that is, a device which is capable of operating to route communications between the UEs and network node 1610b, but which is additionally capable of operating as a communication start and/or end point for certain data channels.

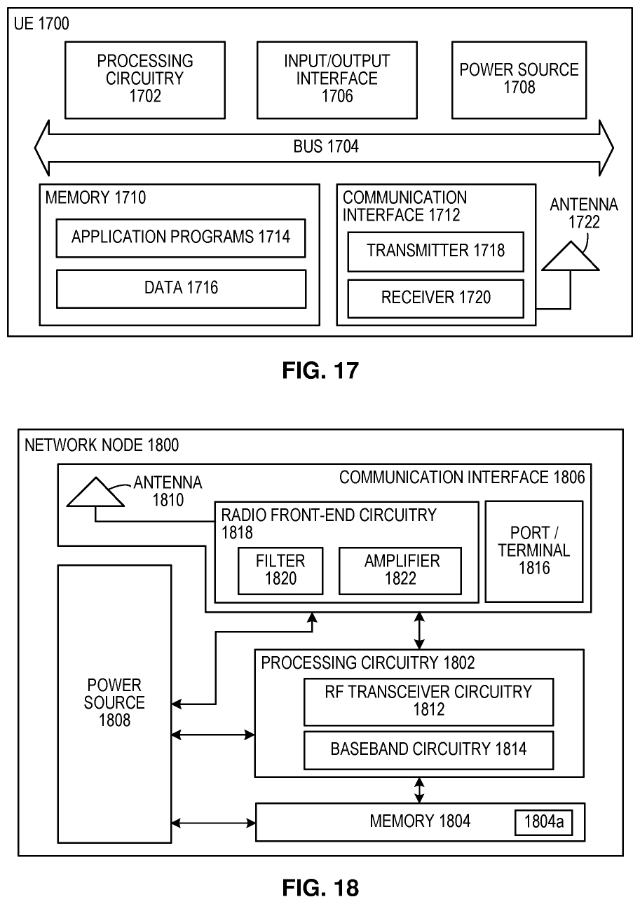

FIG. 17 shows a UE 1700 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1700 includes processing circuitry 1702 that is operatively coupled via bus 1704 to input/output interface 1706, power source 1708, memory 1710, communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

Processing circuitry 1702 is configured to process instructions and data and may be configured to implement any sequential state machine operative to execute instructions stored as machine-readable computer programs in memory 1710. Processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1702 may include multiple central processing units (CPUs).

In the example, input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1708 is structured as a battery or battery pack. Other types of power sources, such as an external power source (e.g., an electricity outlet), photovoltaic device, or power cell, may be used. Power source 1708 may further include power circuitry for delivering power from power source 1708 itself, and/or an external power source, to the various parts of UE 1700 via input circuitry or an interface such as an electrical power cable. Delivering power may be, for example, for charging of power source 1708. Power circuitry may perform any formatting, converting, or other modification to the power from power source 1708 to make the power suitable for the respective components of UE 1700 to which power is supplied.

Memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1710 includes one or more application programs 1714, such as an operating system, web browser application, a widget, gadget engine, or other application, and corresponding data 1716. Memory 1710 may store, for use by UE 1700, any of a variety of various operating systems or combinations of operating systems.

Memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1710 may allow UE 1700 to access instructions, application programs and the like, stored on transitory or non-transitory memory media, to off-load data, or to upload data. An article of manufacture, such as one utilizing a communication system may be tangibly embodied as or in memory 1710, which may be or comprise a device-readable storage medium.

Processing circuitry 1702 may be configured to communicate with an access network or other network using communication interface 1712. Communication interface 1712 may comprise one or more communication subsystems and may include or be communicatively coupled to an antenna 1722. Communication interface 1712 may include one or more transceivers used to communicate, such as by communicating with one or more remote transceivers of another device capable of wireless communication (e.g., another UE or a network node in an access network). Each transceiver may include transmitter 1718 and/or receiver 1720 appropriate to provide network communications (e.g., optical, electrical, frequency allocations, and so forth). Moreover, transmitter 1718 and/or receiver 1720 may be coupled to one or more antennas (e.g., 1722) and may share circuit components, software, or firmware, or alternatively be implemented separately.

In the illustrated embodiment, communication functions of communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1700 shown in FIG. 17.

As another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1800 includes processing circuitry 1802, memory 1804, communication interface 1806, and power source 1808. Network node 1800 may be composed of multiple physically separate components (e.g., a NodeB component and a RNC component, or a BTS component and a BSC component, etc.), which may each have their own respective components. In certain scenarios in which network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). Network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

Processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as memory 1804, to provide network node 1800 functionality.

In some embodiments, processing circuitry 1802 includes a system on a chip (SOC). In some embodiments, processing circuitry 1802 includes radio frequency (RF) transceiver circuitry 1812 and/or baseband processing circuitry 1814. In some embodiments, RF transceiver circuitry 1812 and/or baseband processing circuitry 1814 may be on separate chips (or sets of chips), boards, or units, such as radio units and digital units. In alternative embodiments, part or all of RF transceiver circuitry 1812 and/or baseband processing circuitry 1814 may be on the same chip or set of chips, boards, or units.

Memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1802. Memory 1804 may store any suitable instructions, data, or information, including a computer program, software, an application including one or more of logic, rules, code, tables, and/or other instructions (collectively denoted computer program 1804a, which may be in the form of a computer program product) capable of being executed by processing circuitry 1802 and utilized by network node 1800. Memory 1804 may be used to store any calculations made by processing circuitry 1802 and/or any data received via communication interface 1806. In some embodiments, processing circuitry 1802 and memory 1804 is integrated.

Communication interface 1806 is used in wired or wireless communication of signaling and/or data between a network node, access network, and/or UE. As illustrated, communication interface 1806 comprises port(s)/terminal(s) 1816 to send and receive data, for example to and from a network over a wired connection. Communication interface 1806 also includes radio front-end circuitry 1818 that may be coupled to, or in certain embodiments a part of, antenna 1810. Radio front-end circuitry 1818 comprises filters 1820 and amplifiers 1822. Radio front-end circuitry 1818 may be connected to antenna 1810 and processing circuitry 1802. Radio front-end circuitry 1818 may be configured to condition signals communicated between antenna 1810 and processing circuitry 1802. Radio front-end circuitry 1818 may receive digital data that is to be sent out to other network nodes or UEs via a wireless connection. Radio front-end circuitry 1818 may convert the digital data into a radio signal having the appropriate channel and bandwidth parameters using a combination of filters 1820 and/or amplifiers 1822. The radio signal may then be transmitted via antenna 1810. Similarly, when receiving data, antenna 1810 may collect radio signals which are then converted into digital data by radio front-end circuitry 1818. The digital data may be passed to processing circuitry 1802. In other embodiments, the communication interface may comprise different components and/or different combinations of components.

In certain alternative embodiments, network node 1800 does not include separate radio front-end circuitry 1818, instead, processing circuitry 1802 includes radio front-end circuitry and is connected to antenna 1810. Similarly, in some embodiments, all or some of RF transceiver circuitry 1812 is part of communication interface 1806. In still other embodiments, communication interface 1806 includes one or more ports or terminals 1816, radio front-end circuitry 1818, and RF transceiver circuitry 1812, as part of a radio unit (not shown), and communication interface 1806 communicates with baseband processing circuitry 1814, which is part of a digital unit (not shown).

Antenna 1810 may include one or more antennas, or antenna arrays, configured to send and/or receive wireless signals. Antenna 1810 may be coupled to radio front-end circuitry 1818 and may be any type of antenna capable of transmitting and receiving data and/or signals wirelessly. In certain embodiments, antenna 1810 is separate from network node 1800 and connectable to network node 1800 through an interface or port.

Antenna 1810, communication interface 1806, and/or processing circuitry 1802 may be configured to perform any receiving operations and/or certain obtaining operations described herein as being performed by the network node. Any information, data and/or signals may be received from a UE, another network node and/or any other network equipment. Similarly, antenna 1810, communication interface 1806, and/or processing circuitry 1802 may be configured to perform any transmitting operations described herein as being performed by the network node. Any information, data and/or signals may be transmitted to a UE, another network node and/or any other network equipment.

Power source 1808 provides power to the various components of network node 1800 in a form suitable for the respective components (e.g., at a voltage and current level needed for each respective component). Power source 1808 may further comprise, or be coupled to, power management circuitry to supply the components of network node 1800 with power for performing the functionality described herein. For example, network node 1800 may be connectable to an external power source (e.g., the power grid, an electricity outlet) via an input circuitry or interface such as an electrical cable, whereby the external power source supplies power to power circuitry of power source 1808. As a further example, power source 1808 may comprise a source of power in the form of a battery or battery pack which is connected to, or integrated in, power circuitry. The battery may provide backup power should the external power source fail.

Embodiments of network node 1800 may include additional components beyond those shown in FIG. 18 for providing certain aspects of the network node's functionality, including any of the functionality described herein and/or any functionality necessary to support the subject matter described herein. For example, network node 1800 may include user interface equipment to allow input of information into network node 1800 and to allow output of information from network node 1800. This may allow a user to perform diagnostic, maintenance, repair, and other administrative functions for network node 1800.

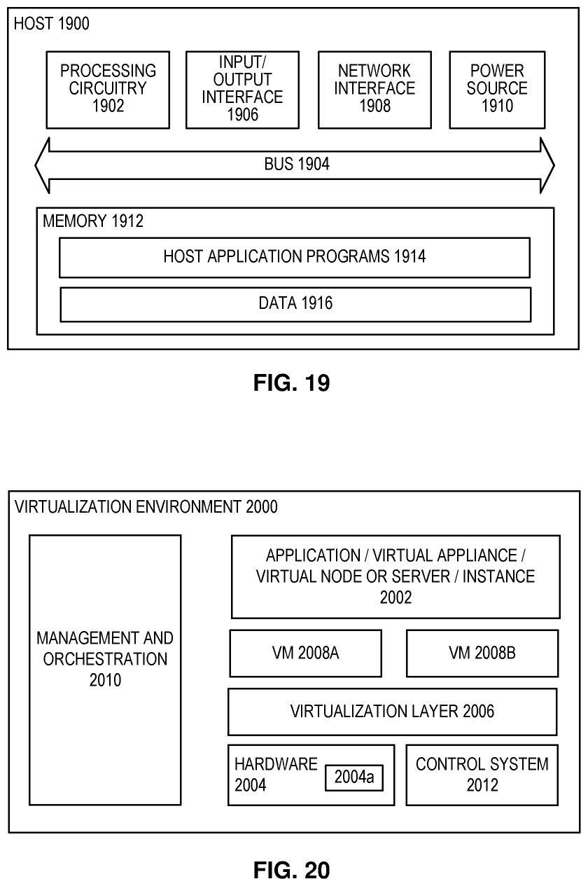

FIG. 19 is a block diagram of a host 1900, which may be an embodiment of host 1616 of FIG. 16, in accordance with various aspects described herein. As used herein, host 1900 may be or comprise various combinations hardware and/or software, including a standalone server, a blade server, a cloud-implemented server, a distributed server, a virtual machine, container, or processing resources in a server farm. Host 1900 may provide one or more services to one or more UEs.

Host 1900 includes processing circuitry 1902 that is operatively coupled via bus 1904 to input/output interface 1906, network interface 1908, power source 1910, and memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

Memory 1912 may include one or more computer programs including one or more host application programs 1914 and data 1916, which may include user data, e.g., data generated by a UE for host 1900 or data generated by host 1900 for a UE. Embodiments of host 1900 may utilize only a subset or all of the components shown. Host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1914 may also provide for user authentication and licensing checks and may periodically report health, routes, and content availability to a central node, such as a device in or on the edge of a core network. Accordingly, host 1900 may select and/or indicate a different host for over-the-top services for a UE. Host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 2000 to implement some of the features, functions, and/or benefits of some of the embodiments disclosed herein.

Hardware 2004 includes processing circuitry, memory that stores software and/or instructions (collectively denoted computer program 2004a, which may be in the form of a computer program product) executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a-b (one or more of which may be generally referred to as VMs 2008), and/or perform any of the functions, features and/or benefits described in relation with some embodiments described herein. Virtualization layer 2006 may present a virtual operating platform that appears like networking hardware to VMs 2008.

VMs 2008 comprise virtual processing, virtual memory, virtual networking or interface and virtual storage, and may be run by a corresponding virtualization layer 2006. Different embodiments of virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2008 may be a software implementation of a physical machine that runs programs as if they were executing on a physical, non-virtualized machine. Each VM 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g., such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

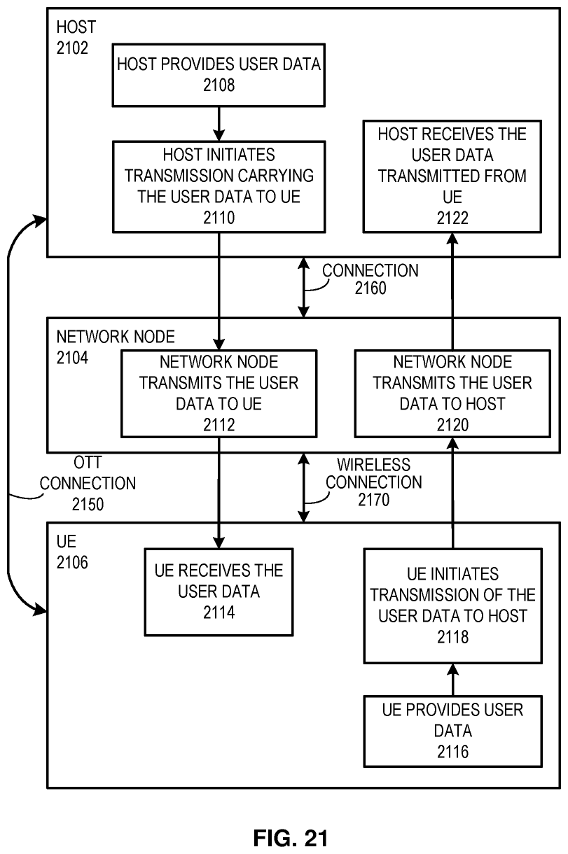

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. Host 2102 also includes software, which is stored in or accessible by host 2102 and executable by the processing circuitry. The software includes a host application that may be operable to provide a service to a remote user, such as UE 2106 connecting via an over-the-top (OTT) connection 2150 extending between UE 2106 and host 2102. In providing the service to the remote user, a host application may provide user data which is transmitted using OTT connection 2150.

Network node 2104 includes hardware enabling it to communicate with host 2102 and UE 2106. Connection 2160 may be direct or pass through a core network (like core network 1606 of FIG. 16) and/or one or more other intermediate networks, such as one or more public, private, or hosted networks. For example, an intermediate network may be a backbone network or the Internet.

UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of host 2102. In host 2102, an executing host application may communicate with the executing client application via OTT connection 2150 terminating at UE 2106 and host 2102. In providing the service to the user, the UE's client application may receive request data from the host's host application and provide user data in response to the request data. OTT connection 2150 may transfer both the request data and the user data. The UE's client application may interact with the user to generate the user data that it provides to the host application through OTT connection 2150.

OTT connection 2150 may extend via a connection 2160 between host 2102 and network node 2104 and via a wireless connection 2170 between network node 2104 and UE 2106 to provide the connection between host 2102 and UE 2106. Connection 2160 and wireless connection 2170, over which OTT connection 2150 may be provided, have been drawn abstractly to illustrate the communication between host 2102 and UE 2106 via network node 2104, without explicit reference to any intermediary devices and the precise routing of messages via these devices.

As an example of transmitting data via OTT connection 2150, in step 2108, host 2102 provides user data, which may be performed by executing a host application. In some embodiments, the user data is associated with a particular human user interacting with UE 2106. In other embodiments, the user data is associated with a UE 2106 that shares data with host 2102 without explicit human interaction. In step 2110, host 2102 initiates a transmission carrying the user data towards UE 2106. Host 2102 may initiate the transmission responsive to a request transmitted by UE 2106. The request may be caused by human interaction with UE 2106 or by operation of the client application executing on UE 2106. The transmission may pass via network node 2104, in accordance with the teachings of the embodiments described throughout this disclosure. Accordingly, in step 2112, network node 2104 transmits to UE 2106 the user data that was carried in the transmission that host 2102 initiated, in accordance with the teachings of the embodiments described throughout this disclosure. In step 2114, UE 2106 receives the user data carried in the transmission, which may be performed by a client application executed on UE 2106 associated with the host application executed by host 2102.

In some examples, UE 2106 executes a client application which provides user data to host 2102. The user data may be provided in reaction or response to the data received from host 2102. Accordingly, in step 2116, UE 2106 may provide user data, which may be performed by executing the client application. In providing the user data, the client application may further consider user input received from the user via an input/output interface of UE 2106. Regardless of the specific manner in which the user data was provided, UE 2106 initiates, in step 2118, transmission of the user data towards host 2102 via network node 2104. In step 2120, in accordance with the teachings of the embodiments described throughout this disclosure, network node 2104 receives user data from UE 2106 and initiates transmission of the received user data towards host 2102. In step 2122, host 2102 receives the user data carried in the transmission initiated by UE 2106.

One or more of the various embodiments improve the performance of OTT services provided to UE 2106 using OTT connection 2150, in which wireless connection 2170 forms the last segment. More precisely, embodiments cand avoid DMRS port collisions (i.e., with other UEs served by the same TRP) when performing rank adaption for a STxMP UE, thereby maintaining full UL capacity for MU-MIMO. Likewise, embodiments avoid network signaling that would otherwise be needed to address DMRS port collisions. Embodiments also facilitate efficient signaling for STxMP UEs by use of a single DMRS port indication (e.g., “antenna ports” field in DCI). These advantages and/or improvements can lead to improved UE UL performance in a RAN (e.g., NG-RAN, E-UTRAN), such as increased UL data rates. When UEs and RANs improved in this manner are used to deliver OTT services to end users, they increase the value of the OTT services to the end users and OTT service providers.

In an example scenario, factory status information may be collected and analyzed by host 2102. As another example, host 2102 may process audio and video data which may have been retrieved from a UE for use in creating maps. As another example, host 2102 may collect and analyze real-time data to assist in controlling vehicle congestion (e.g., controlling traffic lights). As another example, host 2102 may store surveillance video uploaded by a UE. As another example, host 2102 may store or control access to media content such as video, audio, VR or AR which it can broadcast, multicast or unicast to UEs. As other examples, host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 2150 between host 2102 and UE 2106, in response to variations in the measurement results. The measurement procedure and/or the network functionality for reconfiguring the OTT connection may be implemented in software and hardware of host 2102 and/or UE 2106. In some embodiments, sensors (not shown) may be deployed in or in association with other devices through which OTT connection 2150 passes; the sensors may participate in the measurement procedure by supplying values of the monitored quantities exemplified above, or supplying values of other physical quantities from which software may compute or estimate the monitored quantities. The reconfiguring of OTT connection 2150 may include message format, retransmission settings, preferred routing etc.; the reconfiguring need not directly alter the operation of network node 2104. Such procedures and functionalities may be known and practiced in the art. In certain embodiments, measurements may involve proprietary UE signaling that facilitates measurements of throughput, propagation times, latency and the like, by host 2102. The measurements may be implemented in that software causes messages to be transmitted, in particular empty or ‘dummy’ messages, using OTT connection 2150 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured for simultaneous transmission via a plurality of antenna panels, the method comprising:
   transmitting a first plurality of layers of data via the plurality of antenna panels, wherein:
      the first plurality of layers is represented by a first rank, and
      non-overlapping subsets of the first plurality of layers are transmitted via the respective antenna panels;
   receiving, from a RAN node, downlink control information (DCI) scheduling UL transmission of a second plurality of layers represented by a second rank less than the first rank, wherein the DCI indicates demodulation reference signal (DMRS) ports associated with the respective layers of data based on one of the following:
      a first DCI field that indicates a number of UL sounding reference signal (SRS) ports, or
      a second DCI field that indicates DMRS ports based on one of a subset of available field values, wherein the subset is based on the first rank; and
   transmitting the following via the plurality of antenna panels:
      the second plurality of layers of data via respective SRS ports; and
      DMRS via the indicated DMRS ports.
A2. The method of embodiment A1, wherein the first DCI field indicates a number of SRS ports, with the number of DMRS ports used being equal to the indicated number of SRS ports.
A3. The method of embodiment A2, wherein:
   the method further comprises receiving, from the RAN node, an SRS configuration that indicates a respective plurality of SRS resource sets associated with the plurality of antenna panels;
   each SRS resource set includes one or more SRS resources;
   each SRS resource is associated with one or more SRS ports; and
   the number of SRS ports indicated by the first DCI field is a total number of the SRS ports associated with the plurality of antenna panels.
A4. The method of any of embodiments A2-A3, wherein the second rank is less than the number SRS ports.
A5. The method of embodiment A4, wherein:
   a first number of SRS ports (S₁) are associated with a first one of the antenna panels;
   a second number of SRS ports (S₂) are associated with a second one of the antenna panels;
   the DCI schedules a first number of layers (L₁) for transmission via the first number of SRS ports (S₁) and a second number of layers (L₂) for transmission via the second number of SRS ports (S₂);
   the method further comprises determining the DMRS ports used for transmission via the respective antenna panels, based on the following:
      DMRS ports 1 to L₁, for the first antenna panel; and
      DMRS ports S1+1 to S1+L₂, for the second antenna panel.
A6. The method of embodiment A5, wherein one of more of the following applies:
   L1 is less than a corresponding number of layers transmitted via the first antenna panel, according to the first rank; and
   L2 is less than a corresponding number of layers transmitted via the second antenna panel, according to the first rank.
A7. The method of any of embodiments A5-A6, wherein:
   S1-L1 DMRS ports associated with the first antenna panel are determined as unused;
   the S1-L1 unused DMRS ports are associated with a first code division multiplexing (CDM) group and the L1 used DMRS ports are associated with a second CDM group; and
   the second plurality of layers of data are transmitted using UL resources corresponding to the S1-L1 unused DMRS ports.
A8. The method of any of embodiments A1-A7, wherein the first DCI field is one of the following: one or more transmit precoding matrix indicator (TPMI) fields, one or more precoding and number of layers fields, or one or more SRS resource indicator fields.
A9. The method of embodiment A1, wherein the subset of values of the second DCI field indicate respective combinations of DMRS ports, with each combination including at least one DMRS port associated with each of the plurality of antenna panels.
A10. The method of embodiment A9, wherein:
   a first number of SRS ports (S1) are associated with a first one of the antenna panels;
   a second number of SRS ports (S2) are associated with a second one of the antenna panels; and
   the DCI schedules a first number of layers (L1) for transmission via the first number of SRS ports (S1) and a second number of layers (L2) for transmission via the second number of SRS ports (S2).
A11. The method of embodiment A10, wherein the second DCI field includes a value that corresponds to L1 DMRS ports associated with the first antenna panel and L2 DMRS ports associated with the second antenna panel.
A12. The method of embodiment A10, wherein the subset of values include values that correspond to all combinations (L1, L2) where L1≤S1 and L2≤S2.
A13. The method of embodiments A10-A12, wherein one of more of the following applies:
   L1 is less than a corresponding number of layers transmitted via the first antenna panel, according to the first rank; and
   L2 is less than a corresponding number of layers transmitted via the second antenna panel, according to the first rank.
A14. The method of any of embodiments A9-A13, wherein the second DCI field is one of the following: one or more transmit precoding matrix indicator (TPMI) fields, one or more precoding and number of layers fields, or one or more SRS resource indicator fields.
A15. The method of any of embodiments A1-A14, wherein the indicated DMRS ports are associated with a plurality of different transmission reception points (TRPs) of the RAN node, each TRP being a destination for layers of data and DMRS transmitted via a corresponding one of the antenna panels.
B1. A method for a radio access network (RAN) node configured to receive transmissions from a user equipment (UE) arranged for simultaneous transmission via a plurality of UE antenna panels, the method comprising:
   receiving from the UE a first plurality of layers of data via a plurality of transmission reception points (TRPs) associated with the RAN node, wherein:
      the first plurality of layers is represented by a first rank, and
      non-overlapping subsets of the first plurality of layers are received via the respective TRPs;
   transmitting, to the UE, downlink control information (DCI) scheduling UL transmission of a second plurality of layers represented by a second rank less than the first rank, wherein the DCI indicates demodulation reference signal (DMRS) ports associated with the respective layers of data based on one of the following:
      a first DCI field that indicates a number of UL sounding reference signal (SRS) ports, or
      a second DCI field that indicates DMRS ports based on one of a subset of available field values, wherein the subset is based on the first rank; and receiving the following from the UE via the plurality of TRPs:
   the second plurality of layers of data; and
   DMRS via the indicated DMRS ports.
B2. The method of embodiment B1, wherein the first DCI field indicates a number of SRS ports, with the number of DMRS ports used being equal to the indicated number of SRS ports.
B3. The method of embodiment B2, wherein:
   the method further comprises transmitting, to the UE, an SRS configuration that indicates a respective plurality of SRS resource sets associated with the plurality of UE antenna panels;
   each SRS resource set includes one or more SRS resources;
   each SRS resource is associated with one or more SRS ports; and
   the number of SRS ports indicated by the first DCI field is a total number of the SRS ports associated with the plurality of UE antenna panels.
B4. The method of any of embodiments B2-B3, wherein the second rank is less than the number SRS ports.
B5. The method of embodiment B4, wherein:
   a first number of SRS ports (S1) are associated with a first one of the UE antenna panels;
   a second number of SRS ports (S2) are associated with a second one of the antenna panels;
   the DCI schedules a first number of layers (L1) for transmission via the first number of SRS ports (S1) and a second number of layers (L2) for transmission via the second number of SRS ports (S2);
   the first DCI field indicates the following the DMRS ports to be used for transmission via the respective UE antenna panels:
      DMRS ports 1 to L1, for the first UE antenna panel; and
      DMRS ports S1+1 to S1+L2, for the second UE antenna panel.
B6. The method of embodiment B5, wherein one of more of the following applies:
   L1 is less than a corresponding number of layers received via a first one of the TRPs, according to the first rank; and
   L2 is less than a corresponding number of layers received via a second one of the TRPs, according to the first rank.
B7. The method of any of embodiments B5-B6, wherein:
   S1-L1 DMRS ports associated with the first TRP are indicated as unused;
   the S1-L1 unused DMRS ports are associated with a first code division multiplexing (CDM) group and the L1 used DMRS ports are associated with a second CDM group; and
   the second plurality of layers of data are received via UL resources corresponding to the S1-L1 unused DMRS ports.
B8. The method of any of embodiments B5-B6, wherein:
   S1-L1 DMRS ports associated with the first TRP are indicated as unused; and
   the method further comprises transmitting, to a second UE, DCI scheduling transmission by the second UE via UL resources corresponding to the S1-L1 unused DMRS ports.
B9. The method of any of embodiments B1-B8, wherein the first DCI field is one of the following: one or more transmit precoding matrix indicator (TPMI) fields, one or more precoding and number of layers fields, or one or more SRS resource indicator fields.
B10. The method of embodiment B1, wherein the subset of values of the second DCI field indicate respective combinations of DMRS ports, with each combination including at least one DMRS port associated with each of the plurality of UE antenna panels.
B11. The method of embodiment B10, wherein:
   a first number of SRS ports (S1) are associated with a first one of the antenna panels;
   a second number of SRS ports (S2) are associated with a second one of the antenna panels; and
   the DCI schedules a first number of layers (L1) for transmission via the first number of SRS ports (S1) and a second number of layers (L2) for transmission via the second number of SRS ports (S2).
B12. The method of embodiment B11, wherein the second DCI field includes a value that corresponds to L1 DMRS ports associated with the first antenna panel and L2 DMRS ports associated with the second antenna panel.
B13. The method of embodiment B11, wherein the subset of values include values that correspond to all combinations (L1, L2) where L1≤S1 and L2≤S2.
B14. The method of embodiments B11-B13, wherein one of more of the following applies:
   L1 is less than a corresponding number of layers received via a first one of the TRPs, according to the first rank; and
   L2 is less than a corresponding number of layers received via a second one of the TRPs, according to the first rank.
B15. The method of any of embodiments B10-B14, wherein the second DCI field is one of the following: one or more transmit precoding matrix indicator (TPMI) fields, one or more precoding and number of layers fields, or one or more SRS resource indicator fields.
C1. A user equipment (UE) configured for simultaneous transmission via a plurality of antenna panels, the UE comprising:
   a plurality of antenna panels, each antenna panel comprising a plurality of antenna elements;
   communication interface circuitry operably coupled to the plurality of antenna panels and configured to communicate with the RAN; and
   processing circuitry operatively coupled to the communication interface circuitry, whereby the processing circuitry and the communication interface circuitry are configured to perform operations corresponding to any of the methods of embodiments A1-A15.
C2. A user equipment (UE) configured for simultaneous transmission via a plurality of antenna panels, the UE being further configured to perform operations corresponding to any of the methods of embodiments A1-A15.
C3. A non-transitory, computer-readable medium storing computer-executable instructions that, when executed by processing circuitry of a user equipment (UE) configured for simultaneous transmission via a plurality of antenna panels, configure the UE to perform operations corresponding to any of the methods of embodiments A1-A15.
C4. A computer program product comprising computer-executable instructions that, when executed by processing circuitry of a user equipment (UE) configured for simultaneous transmission via a plurality of antenna panels, configure the UE to perform operations corresponding to any of the methods of embodiments A1-A15.
D1. A radio access network (RAN) node configured to receive transmissions from a user equipment (UE) arranged for simultaneous transmission via a plurality of UE antenna panels, the RAN node comprising:
   communication interface circuitry configured to communicate with the UE; and
   processing circuitry operatively coupled to the communication interface circuitry, whereby the processing circuitry and the communication interface circuitry are configured to perform operations corresponding to any of the methods of embodiments B1-B15.
D2. The RAN node of claim D1, wherein the communication interface circuitry includes a plurality of transmission reception points (TRPs) arranged to receive respective transmissions from the plurality of UE antenna panels.
D3. A radio access network (RAN) node configured to receive transmissions from a user equipment (UE) arranged for simultaneous transmission via a plurality of UE antenna panels, the RAN node being further configured to perform operations corresponding to any of the methods of embodiments B1-B15.
D4. A non-transitory, computer-readable medium storing computer-executable instructions that, when executed by processing circuitry of a radio access network (RAN) node configured to receive transmissions from a user equipment (UE) arranged for simultaneous transmission via a plurality of UE antenna panels, configure the RAN node to perform operations corresponding to any of the methods of embodiments B1-B15.
D5. A computer program product comprising computer-executable instructions that, when executed by processing circuitry of a radio access network (RAN) node configured to receive transmissions from a user equipment (UE) arranged for simultaneous transmission via a plurality of UE antenna panels, configure the RAN node to perform operations corresponding to any of the methods of embodiments B1-B15.

1.-35. (canceled)

36. A method for a user equipment (UE) configured for simultaneous multi-panel transmission (STxMP), the method comprising:
receiving, from a radio access network (RAN) node, downlink control information (DCI) scheduling physical uplink shared channel (PUSCH) transmission of a first number of layers (L1) associated with a first sounding reference signal (SRS) resource set and of a second number of layers (L2) associated with a second SRS resource set, wherein:
one or more layer fields in the DCI indicate the first number of layers (L1) and the second number of layers (L2),
a rank of the PUSCH transmission is equal to a sum (L1+L2) of the first number of layers (L1) and the second number of layers (L2),
a value in a ports field in the DCI indicates the following:
L1 demodulation reference signal (DMRS) ports of a first subset of DMRS ports associated with the first SRS resource set; and
L2 DMRS ports of a second subset of DMRS ports associated with the second SRS resource set; and
the first and second subsets of DMRS ports are non-overlapping and are independent of a distribution of the rank between the first number of layers (L1) and the second number of layers (L2); and
transmitting PUSCH and DMRS according to the received DCI.

37. The method of claim 36, wherein:
the value of the ports field in the DCI indicates DMRS ports based on a table mapping the value to DMRS ports; and
the table is selected based on the rank of the PUSCH transmission.

38. The method of claim 36, wherein:
the UE is configured for simultaneous transmission of the first and second SRS resource sets via respective first and second antenna panels,
the first subset of DMRS ports comprises DMRS port 0 and DMRS port 1, and
the second subset of DMRS ports comprises DMRS port 2 and DMRS port 3.

39. The method of claim 37, wherein:
the rank of the PUSCH transmission is equal to 3;
a first value of the ports field in the DCI corresponds to the first number of layers (L1) equal to 2 and the second number of layers (L2) equal to 1;
the first value of the ports field indicates a first entry in the selected table;
the first entry is mapped to DMRS ports 0 and 1 for the transmission on the L1=2 layers and to DMRS port 2 for the transmission on the L2=1 layer;
a second value of the ports field in the DCI corresponds to the first number of layers (L1) equal to 1 and the second number of layers (L2) equal to 2;
the second value of the ports field indicates a second entry in the selected table; and
the second entry is mapped to DMRS port 0 for the transmission on the L1=1 layer and to DMRS ports 2 and 3 for the transmission on the L2=2 layers.

40. The method of claim 36, wherein:
the first subset of DMRS ports is mapped to resource elements of a first code division multiplexing (CDM) group; and
the second subset of DMRS ports is mapped to resource elements of a second CDM group.

41. The method of claim 36, wherein the one or more layer fields are one of the following: one or more precoding information and number of layers fields, or one or more SRS resource indicator fields.

42. The method of claim 36, further comprising receiving, from the RAN node, an SRS configuration configuring the first and second SRS resource sets, wherein each SRS resource set includes one or more SRS resources, and each SRS resource is associated with one or more SRS ports.

43. The method of claim 42, further comprising transmitting SRS resources of the first and second SRS resource sets via respective first and second UE antenna panels, in accordance with the SRS configuration.

44. The method of claim 36, wherein:
the PUSCH and DMRS are transmitted simultaneously via two UE antenna panels;
the L1 DMRS ports are associated with a first transmission reception point (TRP) of the RAN node;
the L2 DMRS ports are associated with a second TRP of the RAN node; and
each TRP is a destination for PUSCH and DMRS transmitted via a corresponding one of the two UE antenna panels.

45. A method for a radio access network (RAN) node configured to receive transmissions from a user equipment (UE) arranged for simultaneous multi-panel transmission (STxMP), the method comprising:
transmitting, to the UE, downlink control information (DCI) scheduling physical uplink shared channel (PUSCH) transmission of a first number of layers (L1) associated with a first sounding reference signal (SRS) resource set and of a second number of layers (L2) associated with a second SRS resource set, wherein:
one or more layer fields in the DCI indicate the first number of layers (L1) and the second number of layers (L2),
a rank of the PUSCH transmission is equal to a sum (L1+L2) of the first number of layers (L1) and the second number of layers (L2),
a value in a ports field in the DCI indicates the following:
L1 demodulation reference signal (DMRS) ports of a first subset of DMRS ports associated with the first SRS resource set, and
L2 DMRS ports of a second subset of DMRS ports associated with the second SRS resource set; and
the first and second subsets of DMRS ports are non-overlapping and independent of a distribution of the rank between the first number of layers (L1) and the second number of layers (L2); and
receiving PUSCH and DMRS from the UE according to the transmitted DCI.

46. The method of claim 45, wherein:
the value of the ports field in the DCI indicates DMRS ports based on a table mapping the value to DMRS ports; and
the table is selected based on the rank of the PUSCH transmission.

47. The method of claim 45, wherein:
the UE is configured for simultaneous transmission of the first and second SRS resource sets via respective first and second antenna panels,
the first subset of DMRS ports comprises DMRS port 0 and DMRS port 1, and
the second subset of DMRS ports comprises DMRS port 2 and DMRS port 3.

48. The method of claim 46, wherein:
the rank of the PUSCH transmission is equal to 3;
a first value of the ports field in the DCI corresponds to the first number of layers (L1) equal to 2 and the second number of layers (L2) equal to 1;
the first value of the ports field indicates a first entry in the selected table;
the first entry is mapped to DMRS ports 0 and 1 for the transmission on the L1=2 layers and to DMRS port 2 for the transmission on the L2=1 layer;
a second value of the ports field in the DCI corresponds to the first number of layers (L1) equal to 2 and the second number of layers (L2) equal to 1;
the second value of the ports field indicates a second entry in the selected table; and
the second entry is mapped to DMRS port 0 for the transmission on the L1=1 layer and to DMRS ports 2 and 3 for the transmission on the L2=2 layers.

49. The method of claim 45, wherein:
the first subset of DMRS ports is mapped to resource elements of a first code division multiplexing (CDM) group; and
the second subset of DMRS ports is mapped to resource elements of a second CDM group.

50. The method of claim 45, wherein the one or more layer fields are one of the following: one or more precoding information and number of layers fields, or one or more SRS resource indicator fields.

51. The method of claim 45, further comprising transmitting, to the UE, an SRS configuration configuring the first and second SRS resource sets, wherein each SRS resource set includes one or more SRS resources, and each SRS resource is associated with one or more SRS ports.

52. The method of claim 51, further comprising receiving SRS resources of the first and second SRS resources sets from respective first and second UE antenna panels, in accordance with the SRS configuration.

53. The method of claim 45, wherein:
the L1 DMRS ports are associated with a first transmission reception point (TRP) of the RAN node,
the L2 DMRS ports are associated with a second TRP of the RAN node,
the PUSCH and DMRS are received simultaneously via the first and second TRPs, and
each TRP receives PUSCH and DMRS transmitted via a corresponding UE antenna panel.

54. A user equipment, UE configured for simultaneous multi-panel transmission (STxMP), the UE comprising:
a plurality of antenna panels, each antenna panel comprising a plurality of antenna elements;
communication interface circuitry operably coupled to the plurality of antenna panels and configured to communicate with a radio access network (RAN) node; and
processing circuitry operatively coupled to the communication interface circuitry, whereby the processing circuitry and the communication interface circuitry are configured to:
receive, from the RAN node, downlink control information (DCI) scheduling physical uplink shared channel (PUSCH) transmission of a first number of layers (L1) associated with a first sounding reference signal (SRS) resource set and of a second number of layers (L2) associated with a second SRS resource set, wherein:
one or more layer fields in the DCI indicate the first number of layers (L1) and the second number of layers (L2),
a rank of the PUSCH transmission is equal to a sum (L1+L2) of the first number of layers (L1) and the second number of layers (L2),
a value in a ports field in the DCI indicates the following:
L1 demodulation reference signal (DMRS) ports of a first subset of DMRS ports associated with the first SRS resource set,
L2 DMRS ports of a second subset of DMRS ports associated with the second SRS resource set; and
the first and second subsets of DMRS ports are non-overlapping and independent of a distribution of the rank between the first number of layers (L1) and the second number of layers (L2); and
transmit PUSCH and DMRS according to the received DCI.

55. A radio access network (RAN) node configured to receive transmissions from a user equipment (UE) arranged for simultaneous multi-panel transmission (STxMP), the RAN node comprising:
communication interface circuitry; and
processing circuitry operatively coupled to the communication interface circuitry, wherein the processing circuitry and the communication interface circuitry are configured to perform the method of claim 45.
